(19) United States
(12) Patent Application Publication
(10) Pub. No.: US 2024/0129173 A1
(43) Pub. Date: Apr. 18, 2024

(54) CYCLIC SHIFT HOPPING FOR UPLINK REFERENCE SIGNALS

(71) Applicant: QUALCOMM Incorporated, San Diego, CA (US)

(72) Inventors: Yitao CHEN, San Diego, CA (US); Mostafa KHOSHNEVISAN, San Diego, CA (US)

(21) Appl. No.: 18/463,044

(22) Filed: Sep. 7, 2023

Related U.S. Application Data
(60) Provisional application No. 63/379,120, filed on Oct. 11, 2022.

(51) Int. Cl. H04L 27/26

(52) U.S. Cl. CPC H04L 27/2613; H04L 27/2605

(57) ABSTRACT

Various aspects of the present disclosure generally relate to wireless communication. In some aspects, a user equipment (UE) may receive a configuration indicating at least one uplink reference signal resource. The UE may transmit a plurality of uplink reference signals, using the at least one uplink reference signal resource, and a cyclic shift for a first port associated with the plurality of uplink reference signals may hop within a subset of a set of possible cyclic shifts. Numerous other aspects are described.

### CROSS-REFERENCE TO RELATED APPLICATION

This patent application claims priority to U.S. Provisional Patent Application No. 63/379,120, filed on Oct. 11, 2022, entitled “CYCLIC SHIFT HOPPING FOR UPLINK REFERENCE SIGNALS” and is assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for cyclic shift hopping.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to receive a configuration indicating at least one uplink reference signal resource. The one or more processors may be configured to transmit a plurality of uplink reference signals, using the at least one uplink reference signal resource, wherein a first cyclic shift for the plurality of uplink reference signals is based at least in part on a function of time measured in increments longer than one symbol.

Some aspects described herein relate to an apparatus for wireless communication at a network entity. The apparatus may include a memory and one or more processors coupled to the memory. The one or more processors may be configured to transmit a configuration indicating at least one uplink reference signal resource. The one or more processors may be configured to receive a plurality of uplink reference signals, using the at least one uplink reference signal resource, wherein a first cyclic shift for the plurality of uplink reference signals is based at least in part on a function of time measured in increments longer than one symbol.

Some aspects described herein relate to an apparatus for wireless communication at a UE. The apparatus may include a memory and one or more processors coupled to the memory. The one or more processors may be configured to receive a configuration indicating at least one uplink reference signal resource. The one or more processors may be configured to transmit on a first port, using the at least one uplink reference signal resource, with a first cyclic shift. The one or more processors may be configured to transmit on a second port, using the at least one uplink reference signal resource, with a second cyclic shift that is selected based at least in part on the first cyclic shift.

Some aspects described herein relate to an apparatus for wireless communication at a network entity. The apparatus may include a memory and one or more processors coupled to the memory. The one or more processors may be configured to transmit a configuration indicating at least one uplink reference signal resource. The one or more processors may be configured to receive a first uplink reference signal associated with a first port, using the at least one uplink reference signal resource, having a first cyclic shift. The one or more processors may be configured to receive a second uplink reference signal associated with a second port, using the at least one uplink reference signal resource, having a second cyclic shift that is selected based at least in part on the first cyclic shift.

Some aspects described herein relate to an apparatus for wireless communication at a UE. The apparatus may include a memory and one or more processors coupled to the memory. The one or more processors may be configured to receive a configuration indicating at least one uplink reference signal resource. The one or more processors may be configured to transmit a plurality of uplink reference signals, using the at least one uplink reference signal resource, wherein a cyclic shift for a first port associated with the plurality of uplink reference signals hops within a subset of a set of possible cyclic shifts.

Some aspects described herein relate to an apparatus for wireless communication at a network entity. The apparatus may include a memory and one or more processors coupled to the memory. The one or more processors may be configured to transmit a configuration indicating at least one uplink reference signal resource. The one or more processors may be configured to receive a plurality of uplink reference signals, using the at least one uplink reference signal resource, wherein a cyclic shift for a first port associated with the plurality of uplink reference signals hops within a subset of a set of possible cyclic shifts.

Some aspects described herein relate to a method of wireless communication performed by a UE. The method may include receiving a configuration indicating at least one uplink reference signal resource. The method may include transmitting a plurality of uplink reference signals, using the at least one uplink reference signal resource, wherein a first cyclic shift for the plurality of uplink reference signals is based at least in part on a function of time measured in increments longer than one symbol.

Some aspects described herein relate to a method of wireless communication performed by a network entity. The method may include transmitting a configuration indicating at least one uplink reference signal resource. The method may include receiving a plurality of uplink reference signals, using the at least one uplink reference signal resource, wherein a first cyclic shift for the plurality of uplink reference signals is based at least in part on a function of time measured in increments longer than one symbol.

Some aspects described herein relate to a method of wireless communication performed by a UE. The method may include receiving a configuration indicating at least one uplink reference signal resource. The method may include transmitting on a first port, using the at least one uplink reference signal resource, with a first cyclic shift. The method may include transmitting on a second port, using the at least one uplink reference signal resource, with a second cyclic shift that is selected based at least in part on the first cyclic shift.

Some aspects described herein relate to a method of wireless communication performed by a network entity. The method may include transmitting a configuration indicating at least one uplink reference signal resource. The method may include receiving a first uplink reference signal associated with a first port, using the at least one uplink reference signal resource, having a first cyclic shift. The method may include receiving a second uplink reference signal associated with a second port, using the at least one uplink reference signal resource, having a second cyclic shift that is selected based at least in part on the first cyclic shift.

Some aspects described herein relate to a method of wireless communication performed by a UE. The method may include receiving a configuration indicating at least one uplink reference signal resource. The method may include transmitting a plurality of uplink reference signals, using the at least one uplink reference signal resource, wherein a cyclic shift for a first port associated with the plurality of uplink reference signals hops within a subset of a set of possible cyclic shifts.

Some aspects described herein relate to a method of wireless communication performed by a network entity. The method may include transmitting a configuration indicating at least one uplink reference signal resource. The method may include receiving a plurality of uplink reference signals, using the at least one uplink reference signal resource, wherein a cyclic shift for a first port associated with the plurality of uplink reference signals hops within a subset of a set of possible cyclic shifts.

Some aspects described herein relate to a non-transitory computer-readable medium that stores a set of instructions for wireless communication by a UE. The set of instructions, when executed by one or more processors of the UE, may cause the UE to receive a configuration indicating at least one uplink reference signal resource. The set of instructions, when executed by one or more processors of the UE, may cause the UE to transmit a plurality of uplink reference signals, using the at least one uplink reference signal resource, wherein a first cyclic shift for the plurality of uplink reference signals is based at least in part on a function of time measured in increments longer than one symbol.

Some aspects described herein relate to a non-transitory computer-readable medium that stores a set of instructions for wireless communication by a network entity. The set of instructions, when executed by one or more processors of the network entity, may cause the network entity to transmit a configuration indicating at least one uplink reference signal resource. The set of instructions, when executed by one or more processors of the network entity, may cause the network entity to receive a plurality of uplink reference signals, using the at least one uplink reference signal resource, wherein a first cyclic shift for the plurality of uplink reference signals is based at least in part on a function of time measured in increments longer than one symbol.

Some aspects described herein relate to a non-transitory computer-readable medium that stores a set of instructions for wireless communication by a UE. The set of instructions, when executed by one or more processors of the UE, may cause the UE to receive a configuration indicating at least one uplink reference signal resource. The set of instructions, when executed by one or more processors of the UE, may cause the UE to transmit on a first port, using the at least one uplink reference signal resource, with a first cyclic shift. The set of instructions, when executed by one or more processors of the UE, may cause the UE to transmit on a second port, using the at least one uplink reference signal resource, with a second cyclic shift that is selected based at least in part on the first cyclic shift.

Some aspects described herein relate to a non-transitory computer-readable medium that stores a set of instructions for wireless communication by a network entity. The set of instructions, when executed by one or more processors of the network entity, may cause the network entity to transmit a configuration indicating at least one uplink reference signal resource. The set of instructions, when executed by one or more processors of the network entity, may cause the network entity to receive a first uplink reference signal associated with a first port, using the at least one uplink reference signal resource, having a first cyclic shift. The set of instructions, when executed by one or more processors of the network entity, may cause the network entity to receive a second uplink reference signal associated with a second port, using the at least one uplink reference signal resource, having a second cyclic shift that is selected based at least in part on the first cyclic shift.

Some aspects described herein relate to a non-transitory computer-readable medium that stores a set of instructions for wireless communication by a UE. The set of instructions, when executed by one or more processors of the UE, may cause the UE to receive a configuration indicating at least one uplink reference signal resource. The set of instructions, when executed by one or more processors of the UE, may cause the UE to transmit a plurality of uplink reference signals, using the at least one uplink reference signal resource, wherein a cyclic shift for a first port associated with the plurality of uplink reference signals hops within a subset of a set of possible cyclic shifts.

Some aspects described herein relate to a non-transitory computer-readable medium that stores a set of instructions for wireless communication by a network entity. The set of instructions, when executed by one or more processors of the network entity, may cause the network entity to transmit a configuration indicating at least one uplink reference signal resource. The set of instructions, when executed by one or more processors of the network entity, may cause the network entity to receive a plurality of uplink reference signals, using the at least one uplink reference signal resource, wherein a cyclic shift for a first port associated with the plurality of uplink reference signals hops within a subset of a set of possible cyclic shifts.

Some aspects described herein relate to an apparatus for wireless communication. The apparatus may include means for receiving a configuration indicating at least one uplink reference signal resource. The apparatus may include means for transmitting a plurality of uplink reference signals, using the at least one uplink reference signal resource, wherein a first cyclic shift for the plurality of uplink reference signals is based at least in part on a function of time measured in increments longer than one symbol.

Some aspects described herein relate to an apparatus for wireless communication. The apparatus may include means for transmitting a configuration indicating at least one uplink reference signal resource. The apparatus may include means for receiving a plurality of uplink reference signals, using the at least one uplink reference signal resource, wherein a first cyclic shift for the plurality of uplink reference signals is based at least in part on a function of time measured in increments longer than one symbol.

Some aspects described herein relate to an apparatus for wireless communication. The apparatus may include means for receiving a configuration indicating at least one uplink reference signal resource. The apparatus may include means for transmitting on a first port, using the at least one uplink reference signal resource, with a first cyclic shift. The apparatus may include means for transmitting on a second port, using the at least one uplink reference signal resource, with a second cyclic shift that is selected based at least in part on the first cyclic shift.

Some aspects described herein relate to an apparatus for wireless communication. The apparatus may include means for transmitting a configuration indicating at least one uplink reference signal resource. The apparatus may include means for receiving a first uplink reference signal associated with a first port, using the at least one uplink reference signal resource, having a first cyclic shift. The apparatus may include means for receiving a second uplink reference signal associated with a second port, using the at least one uplink reference signal resource, having a second cyclic shift that is selected based at least in part on the first cyclic shift.

Some aspects described herein relate to an apparatus for wireless communication. The apparatus may include means for receiving a configuration indicating at least one uplink reference signal resource. The apparatus may include means for transmitting a plurality of uplink reference signals, using the at least one uplink reference signal resource, wherein a cyclic shift for a first port associated with the plurality of uplink reference signals hops within a subset of a set of possible cyclic shifts.

Some aspects described herein relate to an apparatus for wireless communication. The apparatus may include means for transmitting a configuration indicating at least one uplink reference signal resource. The apparatus may include means for receiving a plurality of uplink reference signals, using the at least one uplink reference signal resource, wherein a cyclic shift for a first port associated with the plurality of uplink reference signals hops within a subset of a set of possible cyclic shifts.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example of a comb offset for a sounding reference signal (SRS), in accordance with the present disclosure.

FIG. 5 is a diagram illustrating an example of frequency hopping for an SRS, in accordance with the present disclosure.

FIG. 6 is a diagram illustrating an example associated with time increments longer than one symbol for cyclic shift hopping, in accordance with the present disclosure.

FIG. 7 is a diagram illustrating an example associated with configuring time increments longer than one symbol for cyclic shift hopping, in accordance with the present disclosure.

FIG. 8 is a diagram illustrating an example associated with cyclic shift hopping for multiple ports, in accordance with the present disclosure.

FIG. 9 is a diagram illustrating an example associated with cyclic shift hopping within a subset of a set of possible cyclic shifts, in accordance with the present disclosure.

FIGS. 10, 11, 12, 13, 14, and 15 are diagrams illustrating example processes associated with cyclic shift hopping, in accordance with the present disclosure.

FIGS. 16 and 17 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

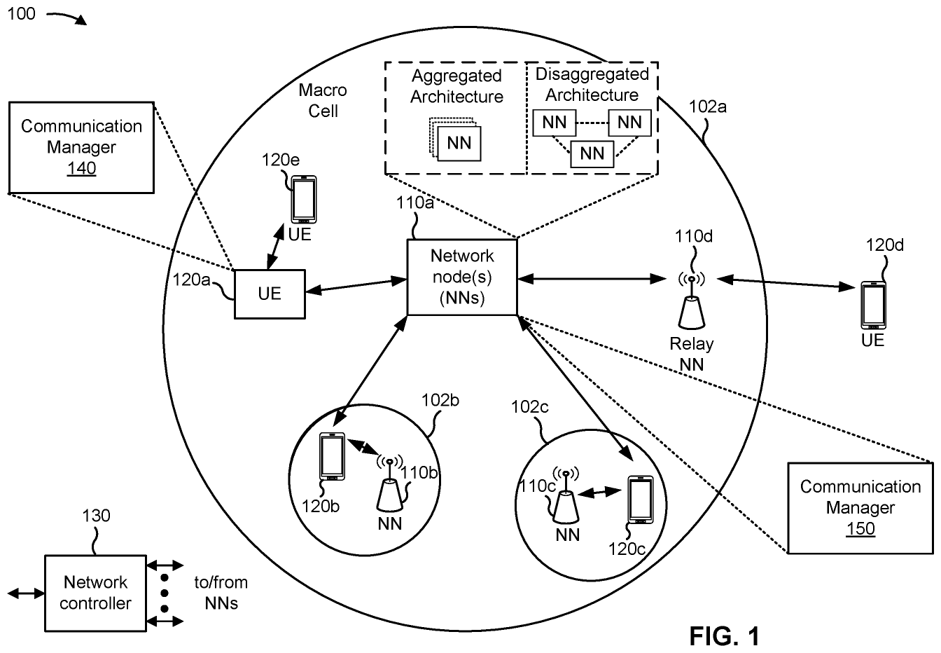

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration indicating at least one uplink reference signal resource and may transmit a plurality of uplink reference signals, using the at least one uplink reference signal resource, where a first cyclic shift for the plurality of uplink reference signals is based at least in part on a function of time measured in increments longer than one symbol. Additionally, or alternatively, as described in more detail elsewhere herein, the communication manager 140 may receive a configuration indicating at least one uplink reference signal resource, may transmit on a first port, using the at least one uplink reference signal resource, with a first cyclic shift, and may transmit on a second port, using the at least one uplink reference signal resource, with a second cyclic shift that is selected based at least in part on the first cyclic shift. Additionally, or alternatively, as described in more detail elsewhere herein, the communication manager 140 may receive a configuration indicating at least one uplink reference signal resource and may transmit a plurality of uplink reference signals, using the at least one uplink reference signal resource, where a cyclic shift for a first port associated with the plurality of uplink reference signals hops within a subset of a set of possible cyclic shifts. Additionally, or alternatively, the communication manager 140 may perform one or more other operations described herein.

In some aspects, a network entity (e.g., the network node 110) may include a communication manager 150. As described in more detail elsewhere herein, the communication manager 150 may transmit a configuration indicating at least one uplink reference signal resource and may receive a plurality of uplink reference signals, using the at least one uplink reference signal resource, where a first cyclic shift for the plurality of uplink reference signals is based at least in part on a function of time measured in increments longer than one symbol. Additionally, or alternatively, as described in more detail elsewhere herein, the communication manager 150 may transmit a configuration indicating at least one uplink reference signal resource, may receive a first uplink reference signal associated with a first port, using the at least one uplink reference signal resource, having a first cyclic shift, and may receive a second uplink reference signal associated with a second port, using the at least one uplink reference signal resource, having a second cyclic shift that is selected based at least in part on the first cyclic shift. Additionally, or alternatively, as described in more detail elsewhere herein, the communication manager 150 may transmit a configuration indicating at least one uplink reference signal resource and may receive a plurality of uplink reference signals, using the at least one uplink reference signal resource, where a cyclic shift for a first port associated with the plurality of uplink reference signals hops within a subset of a set of possible cyclic shifts. Additionally, or alternatively, the communication manager 150 may perform one or more other operations described herein.

As indicated above, FIG. 1 is provided as an example. Other examples may differ from what is described with regard to FIG. 1.

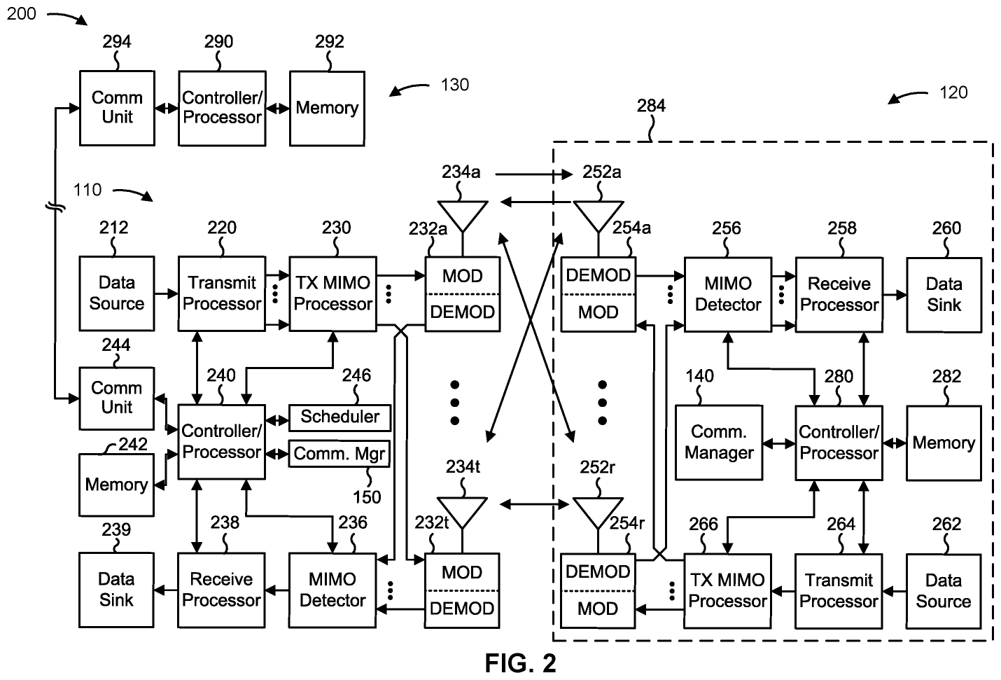

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

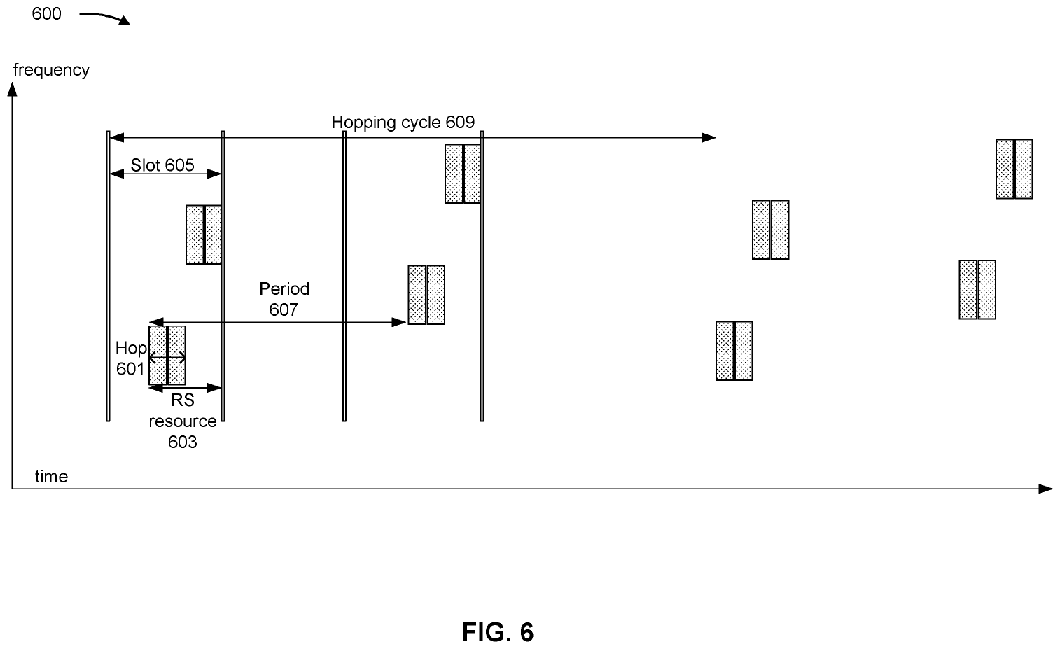

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-17).

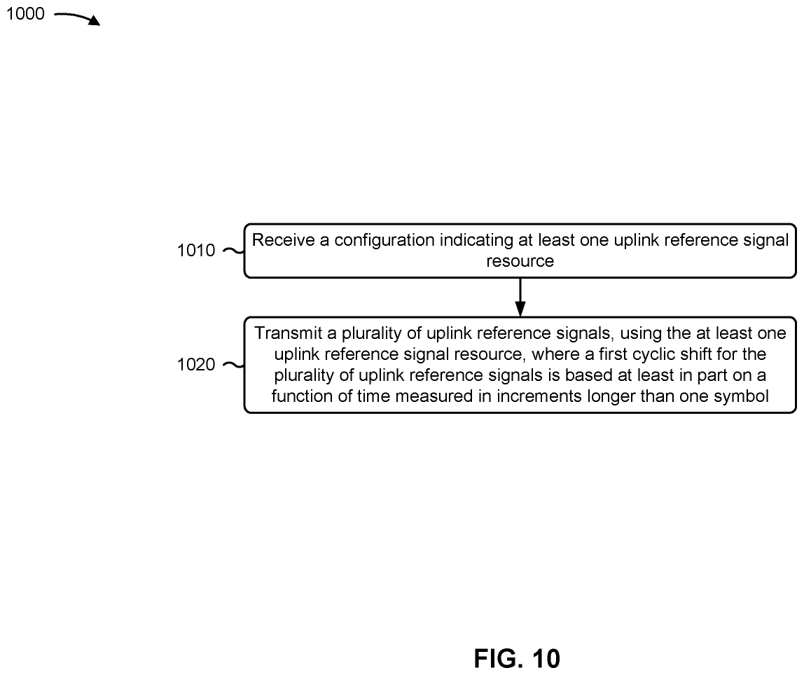

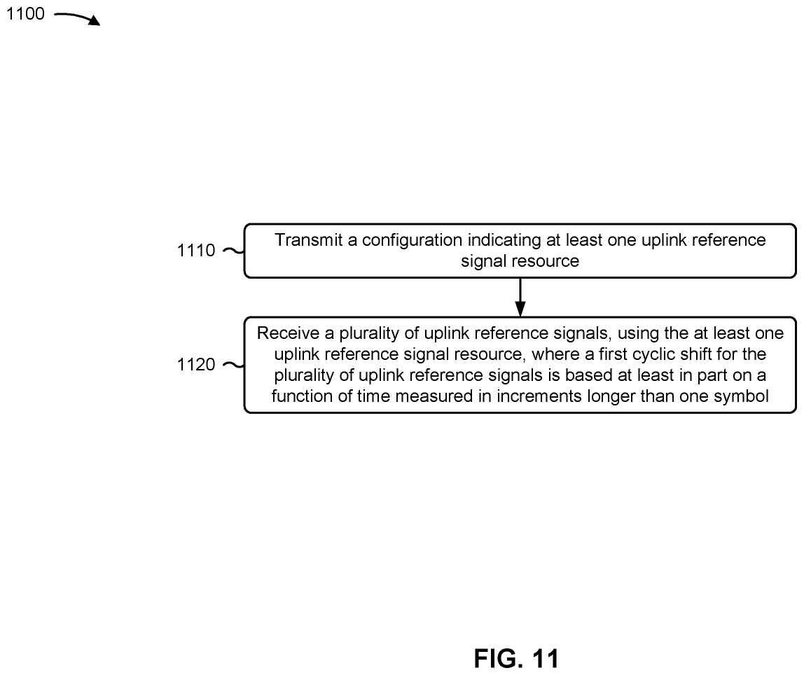

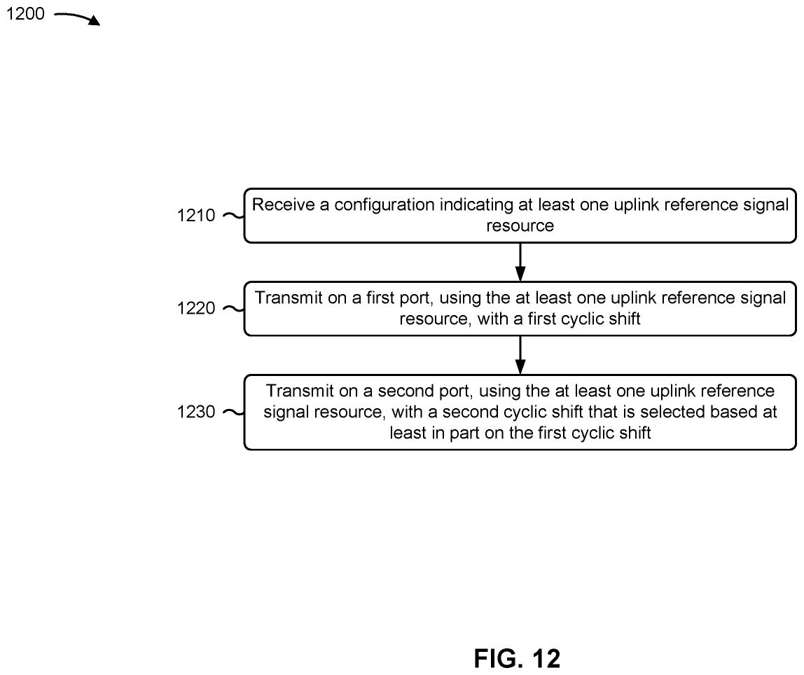

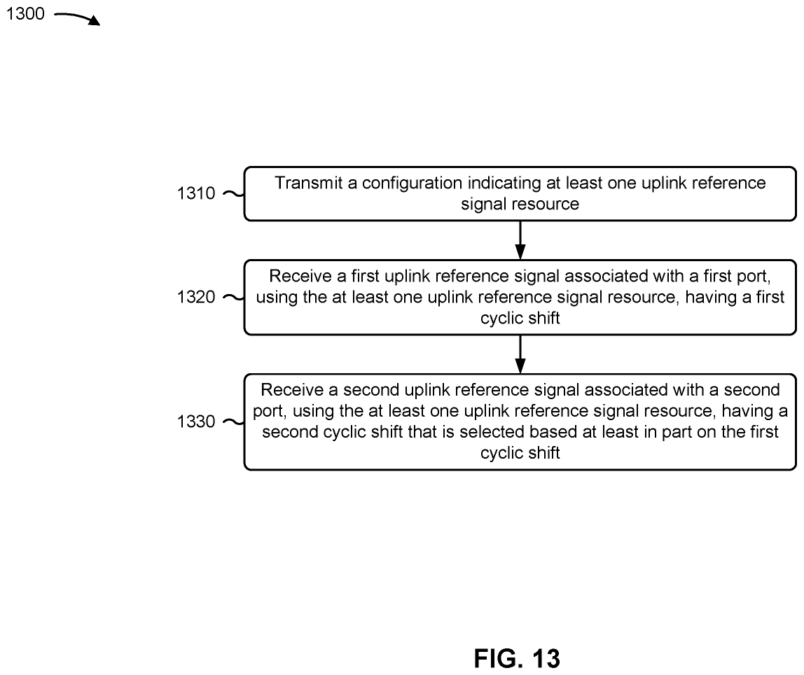

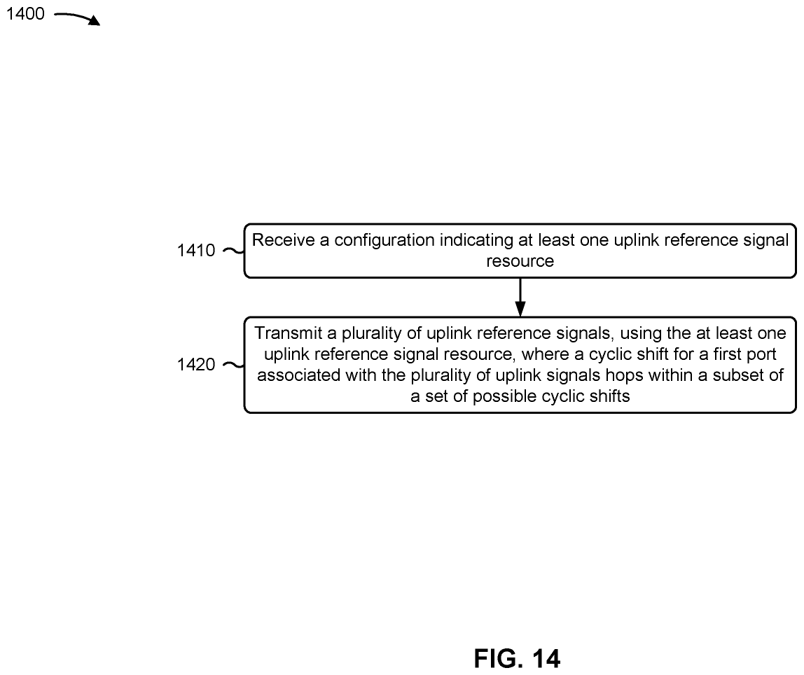

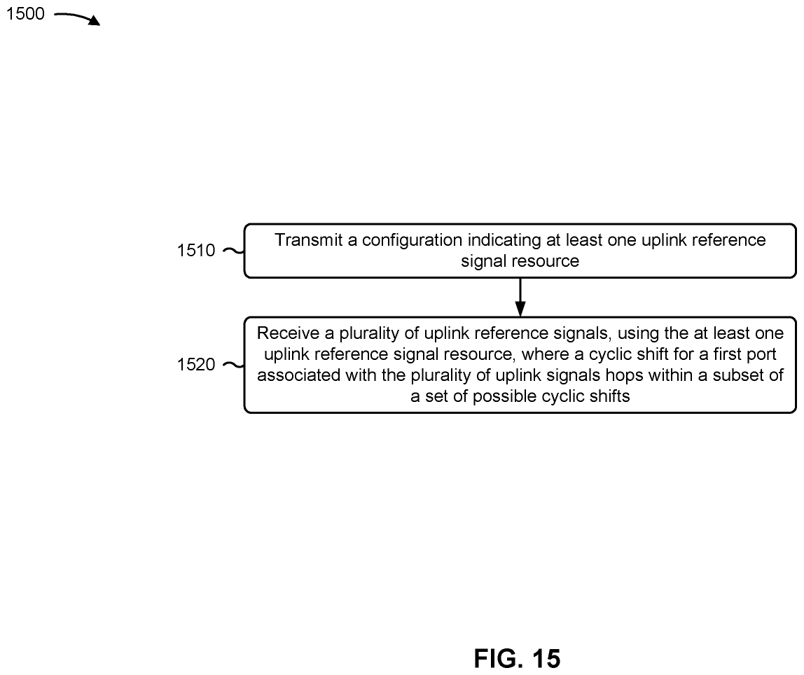

The controller/processor 240 of the network node 110, the controller/processor 280 of the UE 120, and/or any other component(s) of FIG. 2 may perform one or more techniques associated with cyclic shift hopping, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

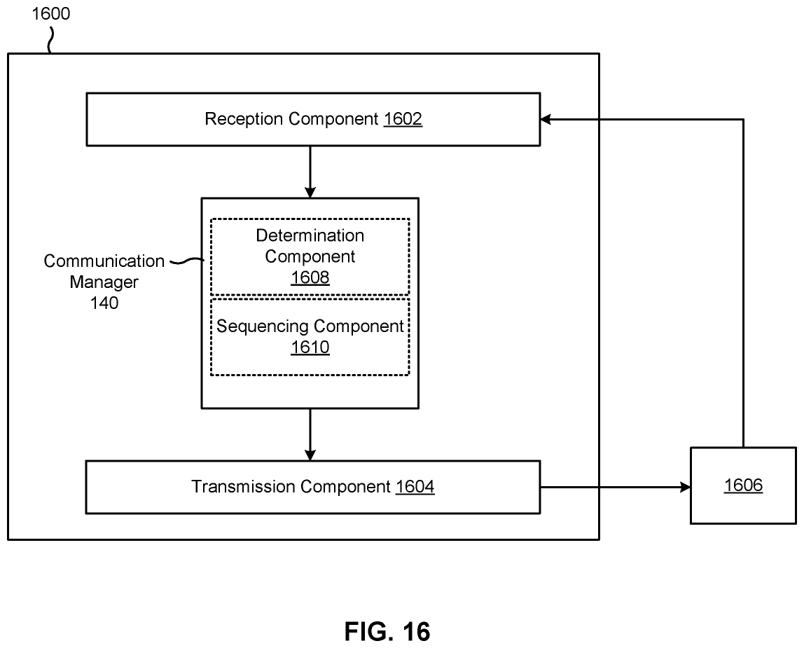

In some aspects, a UE (e.g., the UE 120 and/or apparatus 1600 of FIG. 16) may include means for receiving a configuration indicating at least one uplink reference signal resource; and/or means for transmitting a plurality of uplink reference signals, using the at least one uplink reference signal resource, wherein a first cyclic shift for the plurality of uplink reference signals is based at least in part on a function of time measured in increments longer than one symbol. Additionally, or alternatively, the UE may include means for receiving a configuration indicating at least one uplink reference signal resource; means for transmitting on a first port, using the at least one uplink reference signal resource, with a first cyclic shift; and/or means for transmitting on a second port, using the at least one uplink reference signal resource, with a second cyclic shift that is selected based at least in part on the first cyclic shift. Additionally, or alternatively, the UE may include means for receiving a configuration indicating at least one uplink reference signal resource; and/or means for transmitting a plurality of uplink reference signals, using the at least one uplink reference signal resource, wherein a cyclic shift for a first port associated with the plurality of uplink reference signals hops within a subset of a set of possible cyclic shifts. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

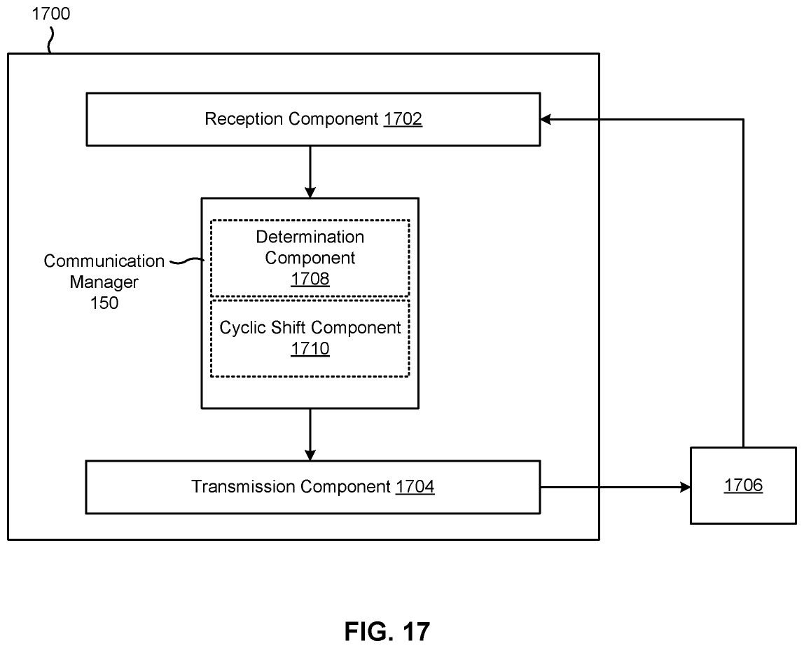

In some aspects, a network entity (e.g., the network node 110, an RU 340, a DU 330, a CU 310, and/or apparatus 1700 of FIG. 17) may include means for transmitting a configuration indicating at least one uplink reference signal resource; and/or means for receiving a plurality of uplink reference signals, using the at least one uplink reference signal resource, wherein a first cyclic shift for the plurality of uplink reference signals is based at least in part on a function of time measured in increments longer than one symbol. Additionally, or alternatively, the network entity may include means for transmitting a configuration indicating at least one uplink reference signal resource; means for receiving a first uplink reference signal associated with a first port, using the at least one uplink reference signal resource, having a first cyclic shift; and/or means for receiving a second uplink reference signal associated with a second port, using the at least one uplink reference signal resource, having a second cyclic shift that is selected based at least in part on the first cyclic shift. Additionally, or alternatively, the network entity may include means for transmitting a configuration indicating at least one uplink reference signal resource; and/or means for receiving a plurality of uplink reference signals, using the at least one uplink reference signal resource, wherein a cyclic shift for a first port associated with the plurality of uplink reference signals hops within a subset of a set of possible cyclic shifts. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

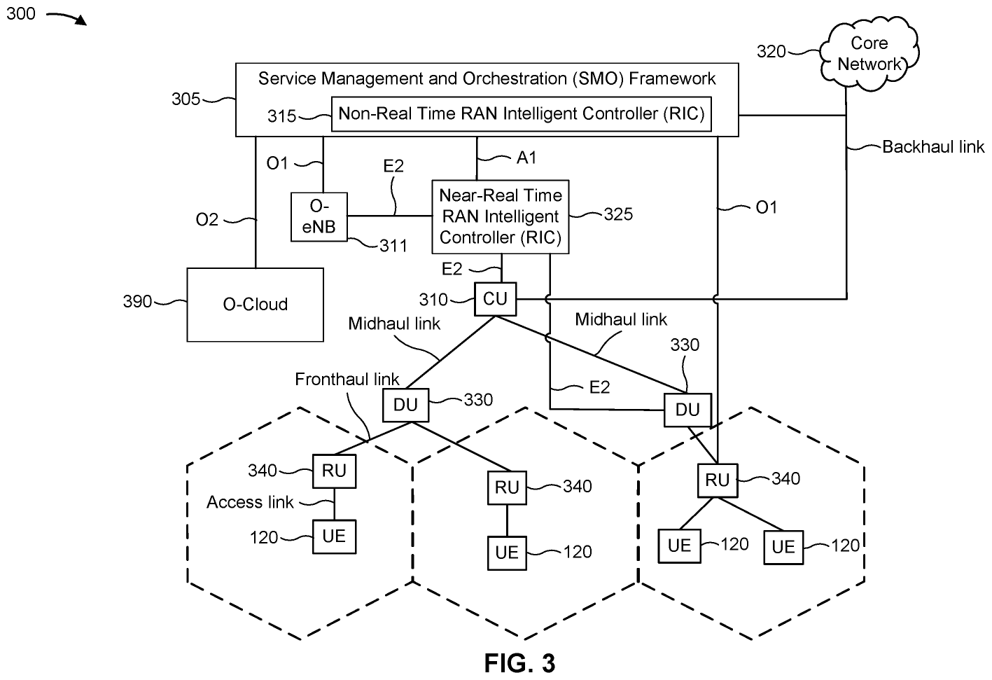

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

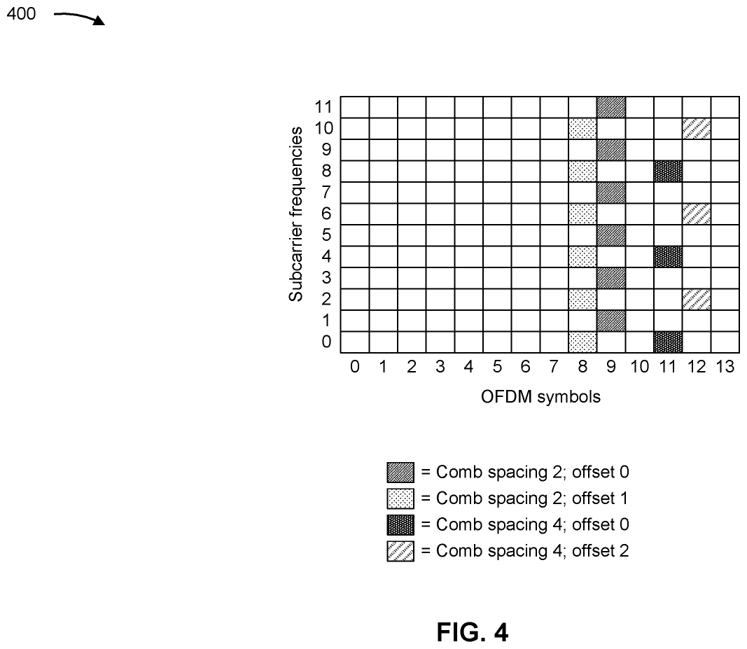

FIG. 4 is a diagram illustrating an example 400 of a comb offset for a sounding reference signal (SRS), in accordance with the present disclosure. In example 400, a UE (e.g., UE 120) may encode a base sequence for an SRS across symbols (e.g., OFDM symbols in example 400 and/or other RF symbols) and subcarriers frequencies based on a configuration from a network (e.g., from a network node 110). As used herein, “subcarrier” may refer to a frequency based at least in part on a “carrier” frequency. The base sequence may be represented by r̅_{u,v}(n), where u∈{0, 1, . . . , 29}=n_{ID}^{SRS} and represents a sequence group identity (ID), and v∈{0,1} and represents a sequence ID. In some situations, each sequence group may include two sequences (e.g., for base sequences of length longer than 72). In some situations, each sequence group may include only one sequence such that v=0 (e.g., for base sequences of length 72 and shorter).

As shown in FIG. 4, the network may indicate a comb spacing (e.g., represented by K_{TC}) for the UE 120 to use. The comb spacing may determine how the SRS is distributed across resource elements (REs). As used herein, “resource element” or “RE” may refer to a resource comprising a single symbol and a single subcarrier. Generally, the UE 120 encodes a single number of the base sequence into a single RE. Example 400 shows example SRSs that have comb spacings of 2 or 4. Other comb spacings, such as 8, may also be used.

As further shown in FIG. 4, the network may indicate a comb offset (e.g., represented by k̅_{TC}) for the UE 120 to use. The comb offset may determine which subcarrier (e.g., which subcarrier index) includes a first portion of the SRS. Example 400 shows example SRSs that have comb offsets of 0, 1, or 2. Other comb offsets (e.g., from 0 through K_{TC}−1) may also be used.

As indicated above, FIG. 4 is provided as an example. Other examples may differ from what is described with respect to FIG. 4.

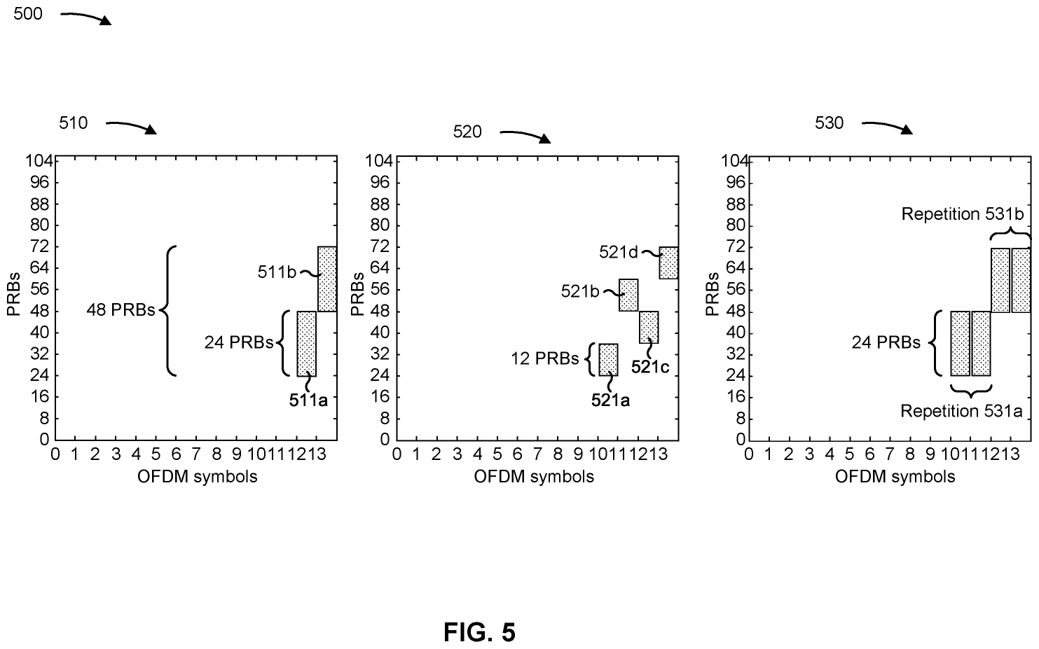

FIG. 5 is a diagram illustrating an example 500 of frequency hopping for an SRS, in accordance with the present disclosure. Example 500, similar to example 400, is associated with SRS encoding within a slot. As used herein, “slot” may refer to a portion of a subframe, which in turn may be a fraction of a radio frame within an LTE, 5G, or another wireless communication structure. In some aspects, a slot may include one or more symbols (e.g., 14 symbols in example 400 and example 500). Additionally, “symbol” may refer to an OFDM symbol or another similar symbol within a slot.

In example 500, a UE (e.g., UE 120) may encode an SRS across a sounding bandwidth (e.g., 48 physical resource blocks (PRBs) in example 500) based on a configuration from a network (e.g., from a network node 110). As used herein, “physical resource block” or “PRB” may refer to one or more subcarriers (e.g., each subcarrier may include one or more frequencies), which may be consecutive in a frequency domain. Accordingly, a PRB may include a plurality of REs, where each RE corresponds to a single subcarrier, as described in connection with FIG. 4.

The network may indicate a quantity of symbols (e.g., represented by N) for the UE 120 to use. Additionally, the network may indicate a quantity of repetitions (e.g., represented by R) for the UE 120 to use. In one example, configuration 510 has N=2 and R=1 such that there are two frequency hops from the SRS sequence 511a in symbol 12 to the SRS sequence 511b in symbol 13. In another example, configuration 520 has N=4 and R=1 such that there are four frequency hops from the SRS sequence 521a in symbol 10 to the SRS sequence 521b in symbol 11 to the SRS sequence 521c in symbol 12 to the SRS sequence 521d in symbol 13. In another example, configuration 530 has N=4 and R=2 such that there are two frequency hops from the SRS repetition 531a across symbols 10 and 11 to the SRS repetition 531b across symbols 12 and 13. The quantity of frequency hops may be determined by N/R. Other quantities of symbols (e.g., 1, 8, 10, 12, and 14, among other examples) and/or other quantities of repetitions (e.g., 3, 4, 5, 6, 7, 8, 10, 12, and 14, among other examples) may be used.

Example 500 is shown for an aperiodic SRS. Accordingly, the network instructs the UE 120 to transmit the SRS a single time. Other examples may use a periodic SRS (e.g., the network instructs the UE 120 to always transmit the SRS periodically) or a semi-persistent SRS (e.g., the network instructs the UE 120 to transmit the SRS periodically once the network transmits an activation message and until the network transmits a deactivation message). For periodic SRS and semi-persistent SRS configurations, frequency hopping may be intra-slot (e.g., as shown in FIG. 5) and/or inter-slot. For inter-slot frequency hopping, a hopping cycle may be longer than a periodicity of the SRS.

When a network configures a UE for transmitting SRSs using multiple ports (also referred to as “antenna ports”), the network may reduce interference using a variety of techniques. For example, the network may separate SRS resources (or SRS resource sets) corresponding to the ports in frequency and/or in time. As used herein, “port” may be defined such that a channel, over which a symbol on the port is conveyed, can be inferred from a channel over which another symbol on the same port is conveyed. Additionally, or alternatively, the network may configure the UE for sequence and/or group hopping such that different base sequences are used across SRS transmissions.

When the network is configuring multiple UEs for transmitting SRSs, the network may additionally (or alternatively) configure the UEs for cyclic shift hopping. A cyclic shift for an SRS may be represented by e^{jα}^{ᵢ}ⁿ, where

$${α}_{i} = 2 π \frac{{n}_{S R S}^{c s i}}{{n}_{S R S}^{cs , max}}$$

and is based on a maximum number of cyclic shifts represented by

$${n}_{S R S}^{cs , max} and {n}_{S R S}^{c s , i} = ( {n}_{SRS}^{c s} + \frac{{n}_{SRS}^{cs , max} ( {p}_{i} - 1000 )}{{N}_{a p}^{SRS}} ) mod {n}_{SRS}^{cs , max} ,$$

where n_{SRS}^{cs} is indicated by the network, pᵢ represents an antenna port being used, and Nₐₚ^{SPS} represents a total quantity of antenna ports for SRS transmission. Accordingly, the network may configure n_{SRS}^{cs} for different UEs to reduce interference or may instruct the UEs to determine the cyclic shift as a function of n_{SRS}^{cs} and symbol index.

In some situations, the network may serve a large number of UEs. Additionally, or alternatively, UEs may transmit SRSs with a high transmit power. For example, in a coherent joint transmission (CJT) configuration, UEs transmit SRSs for reception by multiple TRPs. Accordingly, interference between UEs increases, which wastes power and processing resources at the UEs and at the network because retransmissions are more likely.

Some techniques and apparatuses described herein enable a network (e.g., via the network node 110) to configure a UE (e.g., UE 120) for cyclic shift hopping as a function of time in increments longer than symbols. By configuring a longer period for cyclic shift hopping, the network may monitor for repetitions of an uplink reference signal (e.g., an SRS) in order to improve chances of receiving the uplink reference signal because interference with all repetitions is less likely than with a single transmission. As a result, interference decreases, which conserves power and processing resources at the UE 120 and at the network because retransmissions are less likely.

Additionally, or alternatively, some techniques and apparatuses described herein enable the network to configure the UE 120 to perform cyclic shift hopping for multiple ports. By configuring cyclic shift hopping for multiple ports, the network may monitor for uplink reference signals (e.g., SRSs) across more than one port in order to improve chances of receiving the uplink reference signals because interference with all ports is less likely than with a single port. As a result, interference decreases, which conserves power and processing resources at the UE 120 and at the network because retransmissions are less likely.

As indicated above, FIG. 5 is provided as an example. Other examples may differ from what is described with respect to FIG. 5.

FIG. 6 is a diagram illustrating an example 600 associated with time increments longer than one symbol for cyclic shift hopping, in accordance with the present disclosure. As shown in FIG. 6, example 600 shows uplink reference signals (e.g., SRSs) transmitted by a UE (e.g., UE 120) as a function of time and frequency. In example 600, N=8 and R=2; however, other examples may use a different quantity of symbols (e.g., 1, 2, 4, 10, 12, and 14, among other examples) and/or a different quantity of repetitions (e.g., 3, 4, 5, 6, 7, 8, 10, 12, and 14, among other examples). Additionally, in example 600, the UE 120 is configured for intra-slot hopping in combination with inter-slot hopping. Other examples may include only intra-slot hopping or only inter-slot hopping.

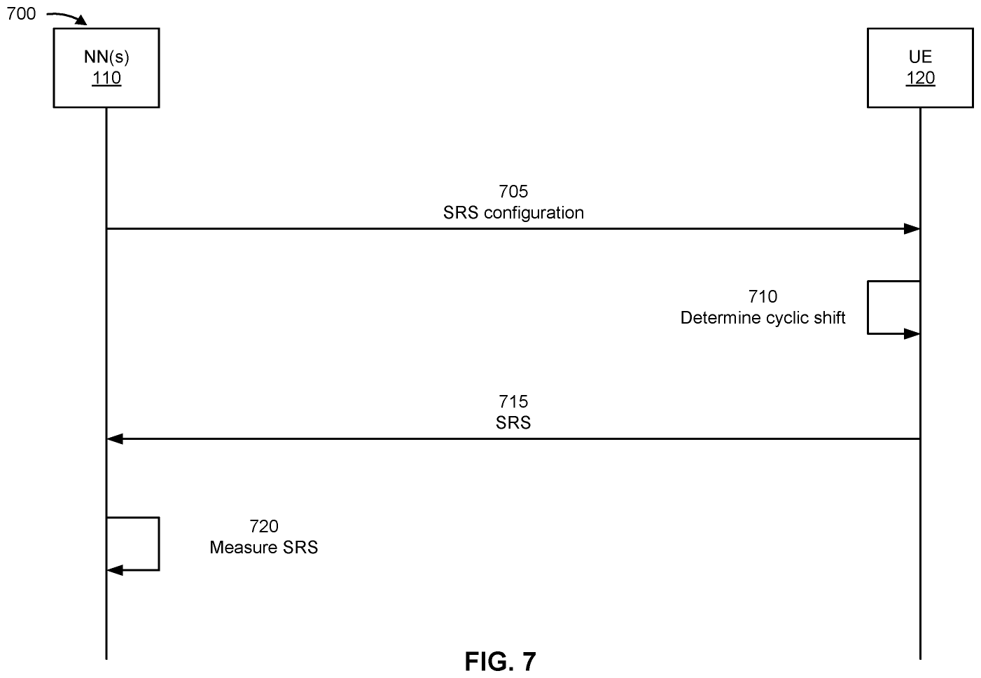

In example 600, a network (e.g., via the network node 110) may configure the UE 120 (e.g., as described in connection with FIG. 7) to perform cyclic shift hopping. Accordingly, the UE 120 may determine the cyclic shift for an SRS (e.g., represented by e^{jα}^{_{i,t}}ⁿ) based at least in part on a function of time (e.g., represented by ƒ(t)). For example, the function of time may comprise a pseudo-random sequence (e.g., represented by c(i)) initialized by a measurement of time (e.g., cᵢₙᵢₜ). In one example, the cyclic shift may be determined according to the following example equation:

$${α}_{0 , t} = \frac{2 π}{{n}_{S R S}^{cs , max}} ( ( {n}_{S R S}^{c s} + {\sum }_{m = 0}^{7} c ( 8 \cdot f ( t ) + m ) \cdot {2}^{m} ) mod {n}_{S R S}^{cs , max} ) ,$$

where ƒ(t) represents the function of time used to initialize the pseudo-random sequence represented by c. Equivalently, the example equation may be written as:

$${α}_{0 , t} = ( \frac{2 π}{{n}_{S R S}^{cs , max}} + \frac{2 π {f}_{C S , hop}}{{n}_{S R S}^{cs , max}} ) ,$$

$$where$$

$${f}_{C S , hop} = ( {\sum }_{m = 0}^{7} c ( 8 \cdot f ( t ) + m ) \cdot {2}^{m} ) mod {n}_{S R S}^{cs , max} .$$

The function of time may be measured in increments longer than one symbol. For example, the function of time may be measured in increments of frequency hops (e.g., shown by hop 601 in FIG. 6). For example, ƒ(t)=ƒ(n_{s,ƒ}^{μ}, l₀+l′)=n_{s,ƒ}^{μ}N_{symb}^{slot}+l₀+l′, where n_{s,ƒ}^{μ} represents a slot index of a slot including the frequency hop, N_{symb}^{slot} represents a quantity of symbols per slot (e.g., 14 symbols per slot in example 600), l₀ represents a first symbol of a resource for the uplink reference signals in the slot, and l′ represents a symbol number of the frequency hop within the resource for the uplink reference signals. Accordingly, the cyclic shift for repetitions in example 600 is the same (for a same port). Similarly, the function of time may be measured in increments of reference signal (RS) resources (e.g., shown by RS resource 603 in FIG. 6). Accordingly, the cyclic shift for uplink reference signals in a same slot and associated with a same resource is the same (for a same port).

In another example, the function of time may be measured in increments of slots (e.g., shown by slot 605 in FIG. 6). For example, ƒ(t)=ƒ(n_{s,ƒ}^{μ})=n_{s,ƒ}^{μ}N_{sumb}^{slot} or ƒ(t)=ƒ(n_{s,ƒ}^{μ},l₀)=n_{s,ƒ}^{μ}N_{sumb}^{slot}+l₀, where n_{s,ƒ}^{μ} represents a slot index. Accordingly, the cyclic shift within each slot in example 600 is the same (for a same port).

In another example, the function of time may be measured in periods for the resource for the uplink reference symbols (e.g., shown by period 607 in FIG. 6). For example, ƒ(t)=ƒ(n_{s,ƒ}^{μ})=n_{s,ƒ}^{μ}N_{sumb}^{slot}, ƒ(t)=ƒ(n_{s,ƒ}^{μ},l₀)=n_{s,ƒ}^{μ}N_{sumb}^{slot}+l₀, or ƒ(t)=ƒ(n_{s,ƒ}^{μ}, l₀+l′)=n_{s,ƒ}^{μ}N_{sumb}^{slot}+l₀+l′, where n_{s,ƒ}^{μ} represents a slot index of a first slot in the period, and l₀+l′ represents a first symbol of the period. Accordingly, the cyclic shift within each period in example 600 is the same (for a same port).

In another example, the function of time may be measured in increments of frequency hopping cycles (e.g., shown by hopping cycle 609 in FIG. 6). For example, ƒ(t)=ƒ(n_{s,ƒ}^{μ})=n_{s,ƒ}^{μ}N_{sumb}^{slot}, ƒ(t)=ƒ(n_{s,ƒ}^{μ},l₀)=n_{s,ƒ}^{μ}N_{sumb}^{slot}+l₀, or ƒ(t)=ƒ(n_{s,ƒ}^{μ},l₀+l′)=n_{s,ƒ}^{μ}N_{sumb}^{slot}+l₀+l′, where n_{s,ƒ}^{μ} represents a slot index of a first slot in the frequency hopping cycle, and l₀+l′ represents a first symbol of the frequency hopping cycle. Accordingly, the cyclic shift within each frequency hopping cycle in example 600 is the same (for a same port).

In some aspects, the first cyclic shift is assigned to a first port, and the UE 120 may limit the first cyclic shift to hopping within a subset of a set of possible cyclic shifts. For example, when n_{SRS}^{cs,max}=12, the network may indicate to the UE 120 that only the first four cyclic shifts (e.g., corresponding to n_{SRS}^{cs}=0, 1, 2, or 3) may be used for the first port. Other examples may include different maximum quantities of cyclic shifts and/or different quantities of cyclic shifts available for the first port.

The UE 120 may use the function of time to determine a first cyclic shift assigned to a first port, as described above. Further, the UE 120 may determine one or more additional cyclic shifts, assigned to one or more additional ports, based on the first cyclic shift. In some aspects, the UE 120 may evenly distribute cyclic shifts among remaining ports. In one example, an additional cyclic shift may be determined according to the following example equation:

$${α}_{i , t} = {α}_{0 , t} + \frac{2 π i}{{N}_{a p}^{S R S}} ,$$

where α_{0,t} represents the first cyclic shift and i represents an index of an additional port.

By using techniques as described in connection with FIG. 6, the network (e.g., via the network node 110) configures the UE 120 for cyclic shift hopping as a function of time in increments longer than one symbol. By configuring a longer period for cyclic shift hopping, the network may monitor for repetitions of the uplink reference signal in order to improve chances of receiving the uplink reference signal because interference with all repetitions is less likely than with a single transmission. As a result, interference decreases, which conserves power and processing resources at the UE 120 and at the network because retransmissions are less likely.

As indicated above, FIG. 6 is provided as an example. Other examples may differ from what is described with respect to FIG. 6.

FIG. 7 is a diagram illustrating an example 700 associated with configuring time increments longer than one symbol for cyclic shift hopping, in accordance with the present disclosure. As shown in FIG. 7, one or more network nodes 110 (e.g., an RU 340 and/or a device controlling the RU 340, such as a DU 330 and/or a CU 310) and a UE 120 may communicate with one another (e.g., on a wireless network, such as wireless network 100 of FIG. 1).

As shown by reference number 705, the network node(s) 110 may transmit (e.g., directly or via the RU 340), and the UE 120 may receive, a configuration for one or more SRSs (or another type of uplink reference signal). The configuration may indicate a base sequence, a comb spacing, and a comb offset to use, as described in connection with FIG. 4. In some aspects, the configuration may indicate that the UE 120 should perform frequency hopping (e.g., as described in connection with FIG. 5).

Additionally, the configuration may indicate that the UE 120 should perform cyclic shift hopping, as described in connection with FIG. 6. The configuration may indicate the increment of time to use in hopping between cyclic shifts, which may be longer than one symbol.

As shown by reference number 710, the UE 120 may determine one or more cyclic shifts for the SRS(s). For example, as described in connection with FIG. 6, the UE 120 may determine a first cyclic shift (based on a function of time) for a first port and determine additional cyclic shifts for additional ports, if any, based on the first cyclic shift.

As shown by reference number 715, the UE 120 may transmit, and the network node(s) 110 may receive (e.g., directly or via the RU 340), the SRS(s). For example, as shown by reference number 720, the network node(s) 110 may measure the SRS(s) in order to schedule uplink transmissions from the UE 120 and/or downlink transmissions to the UE 120 based on measurements of the SRS(s).

By using techniques as described in connection with FIG. 7, the network node(s) 110 configure the UE 120 for cyclic shift hopping as a function of time in increments longer than one symbol. By configuring a longer period for cyclic shift hopping, the network node(s) 110 may monitor for repetitions of the SRS(s) in order to improve chances of receiving the SRS(s) because interference with all repetitions is less likely than with a single transmission. As a result, interference decreases, which conserves power and processing resources at the UE 120 and at the network node(s) 110 because retransmissions are less likely.

As indicated above, FIG. 7 is provided as an example. Other examples may differ from what is described with respect to FIG. 7.

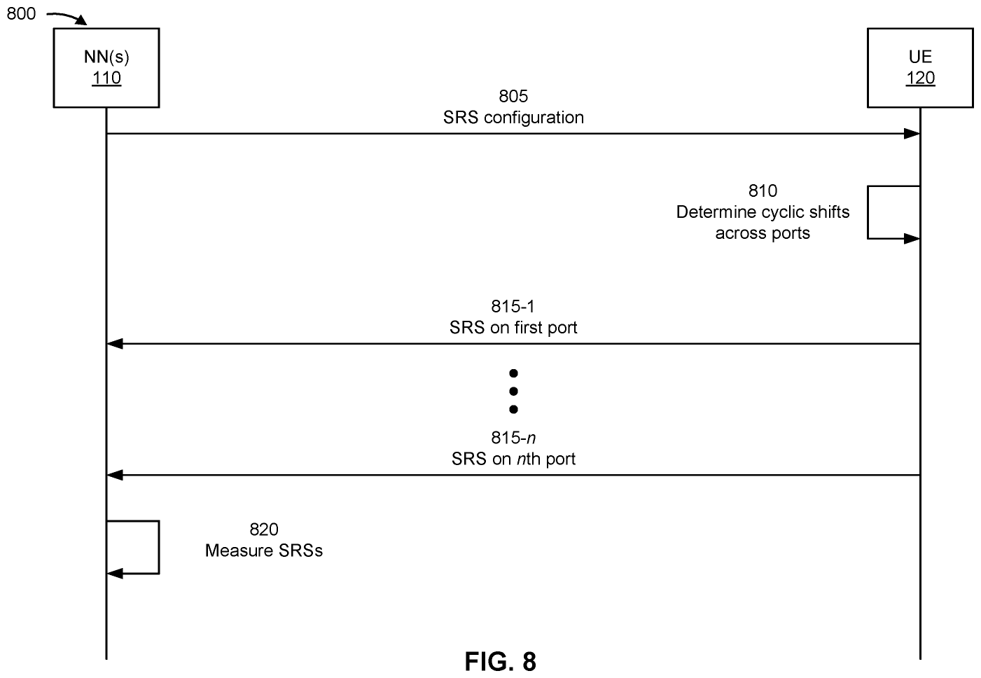

FIG. 8 is a diagram illustrating an example 800 associated with cyclic shift hopping for multiple ports, in accordance with the present disclosure. As shown in FIG. 8, one or more network nodes 110 (e.g., an RU 340 and/or a device controlling the RU 340, such as a DU 330 and/or a CU 310) and a UE 120 may communicate with one another (e.g., on a wireless network, such as wireless network 100 of FIG. 1).

As shown by reference number 805, the network node(s) 110 may transmit (e.g., directly or via the RU 340), and the UE 120 may receive, a configuration for SRSs (or another type of uplink reference signal). The configuration may indicate a base sequence, a comb spacing, and a comb offset to use, as described in connection with FIG. 4. In some aspects, the configuration may indicate that the UE 120 should perform frequency hopping (e.g., as described in connection with FIG. 5).

Additionally, the configuration may indicate that the UE 120 should perform cyclic shift hopping. In some aspects, the configuration may indicate a hopping formula to use that accepts a measurement of time as input and outputs a cyclic shift to use.

As shown by reference number 810, the UE 120 may determine cyclic shifts to use across multiple ports. For example, the UE 120 may determine at least a first cyclic shift to use on a first port and a second cyclic shift to use on a second port.

In some aspects, the UE 120 may determine the first cyclic shift using a first output from the hopping formula and may determine the second cyclic shift using a second output from the hopping formula. In order to prevent collision, the UE 120 may re-determine the second cyclic shift using an offset from the first cyclic shift when the first output and the second output are the same. Accordingly, the UE 120 determines the second cyclic shift based at least in part on the first cyclic shift when the hopping formula generates a same output for both the first port and the second port. For example, the UE 120 may determine the second cyclic shift as α_{0,t}²=(α_{0,t}¹+Δ)mod n_{SRS}^{cs,max}, where α_{0,t}¹ represents the cyclic shift for the first port, and Δ represents the offset.

The offset may be indicated by the network node(s) 110 (e.g., in the configuration described above or in a separate message). Additionally, or alternatively, the UE 120 may store in a memory (and/or otherwise be programmed with) the offset (e.g., according to 3GPP specifications and/or another standard). In a combinatory example, the network node(s) 110 may indicate an offset to use out of a plurality of possible offsets with which the UE 120 is programmed.

Alternatively, the UE 120 may determine the first cyclic shift using a first output from the hopping formula and may determine the second cyclic shift using the offset from the first cyclic shift. Accordingly, the UE 120 may always determine the second cyclic shift based at least in part on the first cyclic shift. For example, the UE 120 may determine the second cyclic shift as α_{0,t}²=(α_{0,t}¹+Δ) mod n_{SRS}^{cs,max}, where α_{0,t}¹ represents the cyclic shift for the first port, and A represents the offset.

In some aspects, the UE 120 may limit the first cyclic shift to hopping within a first subset of a set of possible cyclic shifts, and the second cyclic shift to hopping within a second subset of the set of possible cyclic shifts. For example, when n_{SRS}^{cs,max}=8, the network node(s) 110 may indicate to the UE 120 that only the first four cyclic shifts (e.g., corresponding to n_{SRS}^{cs}=0, 1, 2, or 3) may be used for the first port and that only the second four cyclic shifts (e.g., corresponding to n_{SRS}^{cs}=4, 5, 6, or 7) may be used for the second port. Other examples may include different maximum quantities of cyclic shifts and/or different quantities of cyclic shifts available for the ports.

Although described above in connection with two ports, other examples may include additional ports. Moreover, although described above in connection with individual ports, the first port may be associated with a first group of ports, and the second port may be associated with a second group of ports. Accordingly, the UE 120 may assign one or more additional cyclic shifts to one or more additional ports in the first group of ports based on the first cyclic shift. In some aspects, the UE 120 may evenly distribute cyclic shifts among remaining ports of the first group. In one example, an additional cyclic shift may be determined according to the following example equation:

$${α}_{i , t}^{1} = {α}_{0 , t}^{1} + \frac{2 π i}{{N}_{a p}^{S R S}} ,$$

where α_{0,t}¹ represents the cyclic shift for the first port of the first group and i represents an index of an additional port in the first group.

Similarly, the UE 120 may assign one or more additional cyclic shifts to one or more additional ports in the second group of ports based on the second cyclic shift. In some aspects, the UE 120 may evenly distribute cyclic shifts among remaining ports of the second group. In one example, an additional cyclic shift may be determined according to the following example equation:

$${α}_{i , t}^{2} = {α}_{0 , t}^{2} + \frac{2 π i}{{N}_{a p}^{S R S}} ,$$

where α_{0,t}² represents the cyclic shift for the second port (which, in this example, is the first port of the second group) and i represents an index of an additional port in the second group.

Alternatively, the UE 120 may use assignment sets to assign cyclic shifts across ports. For example, each assignment set may indicate cyclic shift indices to use for all ports (e.g., for 4 ports, an assignment set may be {0, 1, 6, 7}, {2, 3, 8, 9}, or {4, 5, 10, 11}, among other examples). The assignment sets may be indicated by the network node(s) 110 (e.g., in the configuration described above or in a separate message) and/or stored in a memory of (and/or otherwise be programmed into) the UE 120 (e.g., according to 3GPP specifications and/or another standard). Each assignment set may correspond to a unique assignment index.

Accordingly, the UE 120 may determine an assignment index to use using output from the hopping formula, rather than determining a cyclic shift to use using output from the hopping formula. For example, the UE 120 may use the following example equation:

$$h ( t ) = h ( {n}_{s , f}^{μ} , {l}^{′} ) = ( {\sum }_{m = 0}^{M - 1} c ( M \cdot ( {n}_{s , f}^{μ} {N}_{s y m b}^{slot} + {l}_{0} + {l}^{′} ) + m ) \cdot {2}^{m} ) mod H ,$$

where h(t) represents the assignment index to use and H represents the total quantity of assignment sets. In one example, if assignment sets {0, 1, 6, 7}, {2, 3, 8, 9}, and {4, 5, 10, 11} are associated with assignment indices 0, 1, and 2, respectively, then when h(t)=1, the UE 120 may assign cyclic shifts corresponding to indices 2, 3, 8, and 9 to the ports corresponding to indices 0, 1, 2, and 3, respectively.

In some aspects, the UE 120 may limit the assignment index to hopping within a subset of a set of possible assignment indices. For example, when H=8, the network node(s) 110 may indicate to the UE 120 that only the first four assignment sets (e.g., corresponding to h=0, 1, 2, or 3) may be used. Other examples may include different maximum quantities of assignment sets and/or different quantities of assignment indices available for the UE 120 to use.

As shown by reference number 815-1, the UE 120 may transmit, and the network node(s) 110 may receive (e.g., directly or via the RU 340), the SRS associated with the first port. Furthermore, as shown by reference number 815-n, the UE 120 may transmit, and the network node(s) 110 may receive (e.g., directly or via the RU 340), the SRS associated with additional ports (e.g., the second port) through all n ports configured to transmit the SRS. As shown by reference number 820, the network node(s) 110 may measure the SRSs in order to schedule uplink transmissions from the UE 120 and/or downlink transmissions to the UE 120 based on measurements of the SRSs.

By using techniques as described in connection with FIG. 8, the network node(s) 110 may configure the UE 120 to perform cyclic shift hopping for multiple ports. By configuring cyclic shift hopping for multiple ports, the network node(s) 110 may monitor for the SRSs across more than one port in order to improve chances of receiving the SRSs because interference with all ports is less likely than with a single port. As a result, interference decreases, which conserves power and processing resources at the UE 120 and at the network node(s) 110 because retransmissions are less likely.

Example 800 may be combined with examples 700 and 600. For example, the hopping formula of example 800 may be the function of time, measured in increments longer than one symbol, of examples 700 and 600.

As indicated above, FIG. 8 is provided as an example. Other examples may differ from what is described with respect to FIG. 8.

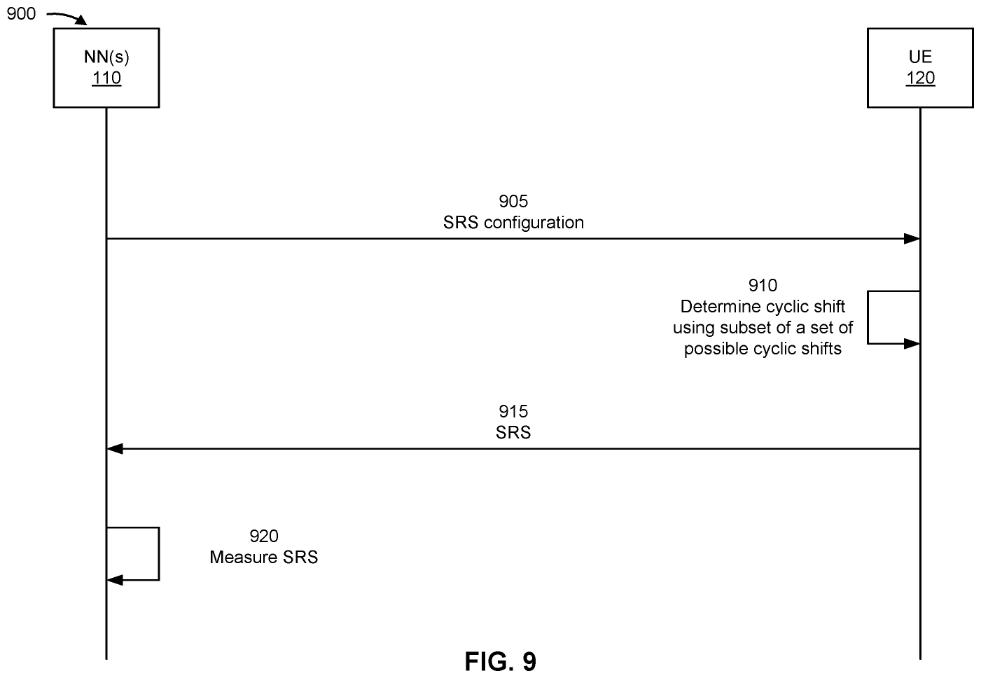

FIG. 9 is a diagram illustrating an example 900 associated with cyclic shift hopping within a subset of a set of possible cyclic shifts, in accordance with the present disclosure. As shown in FIG. 9, one or more network nodes 110 (e.g., an RU 340 and/or a device controlling the RU 340, such as a DU 330 and/or a CU 310) and a UE 120 may communicate with one another (e.g., on a wireless network, such as wireless network 100 of FIG. 1).

As shown by reference number 905, the network node(s) 110 may transmit (e.g., directly or via the RU 340), and the UE 120 may receive, a configuration for one or more SRSs (or another type of uplink reference signal). The configuration may indicate a base sequence, a comb spacing, and a comb offset to use, as described in connection with FIG. 4. In some aspects, the configuration may indicate that the UE 120 should perform frequency hopping (e.g., as described in connection with FIG. 5).

Additionally, the configuration may indicate that the UE 120 should perform cyclic shift hopping. In some aspects, the configuration may further indicate that the UE 120 should only hop within a subset out of a set of possible cyclic shifts. For example, the network node(s) 110 may indicate different subsets to different UEs in order to reduce interference.

As shown by reference number 910, the UE 120 may determine one or more cyclic shifts for the SRS(s). The UE 120 may determine a first cyclic shift, from the subset, for a first port and determine additional cyclic shifts for additional ports, if any, based on the first cyclic shift. For example, when the set of cyclic shifts includes 12 cyclic shifts, the network node(s) 110 may indicate to the UE 120 that only the first four cyclic shifts are included in the subset, such that the UE 120 determines the first cyclic shift from the subset including the cyclic shift associated with indices 0, 1, 2, and 3. Other examples may include different quantities of cyclic shifts included in the set and/or different quantities of cyclic shifts included in the subset.

As shown by reference number 915, the UE 120 may transmit, and the network node(s) 110 may receive (e.g., directly or via the RU 340), the SRS(s). For example, as shown by reference number 920, the network node(s) 110 may measure the SRS(s) in order to schedule uplink transmissions from the UE 120 and/or downlink transmissions to the UE 120 based on measurements of the SRS(s).

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120 and/or apparatus 1600 of FIG. 16) performs operations associated with cyclic shift hopping.

As shown in FIG. 10, in some aspects, process 1000 may include receiving a configuration indicating at least one uplink reference signal resource (block 1010). For example, the UE (e.g., using communication manager 140 and/or reception component 1602, depicted in FIG. 16) may receive a configuration indicating at least one uplink reference signal resource, as described herein.

As further shown in FIG. 10, in some aspects, process 1000 may include transmitting a plurality of uplink reference signals, using the at least one uplink reference signal resource, where a first cyclic shift for the plurality of uplink reference signals is based at least in part on a function of time measured in increments longer than one symbol (block 1020). For example, the UE (e.g., using communication manager 140 and/or transmission component 1604, depicted in FIG. 16) may transmit a plurality of uplink reference signals, using the at least one uplink reference signal resource, where a first cyclic shift for the plurality of uplink reference signals is based at least in part on a function of time measured in increments longer than one symbol, as described herein.

Process 1000 may include additional aspects, such as any single aspect or any combination of aspects described below and/or in connection with one or more other processes described elsewhere herein.

In a first aspect, the plurality of uplink reference signals comprise SRSs.

In a second aspect, alone or in combination with the first aspect, the function of time comprises a pseudo-random sequence initialized by a measurement of time.

In a third aspect, alone or in combination with one or more of the first and second aspects, the first cyclic shift is assigned to a first port associated with the at least one uplink reference signal resource, and one or more additional cyclic shifts are assigned to one or more additional ports based on the first cyclic shift.

In a fourth aspect, alone or in combination with one or more of the first through third aspects, the first cyclic shift is assigned to a first port and hops within a subset of a set of possible cyclic shifts.

In a fifth aspect, alone or in combination with one or more of the first through fourth aspects, the function of time is measured in increments of frequency hops.

In a sixth aspect, alone or in combination with one or more of the first through fifth aspects, the function of time is measured in increments of slots.

In a seventh aspect, alone or in combination with one or more of the first through sixth aspects, the function of time is measured in periods for the at least one uplink reference signal resource.

In an eighth aspect, alone or in combination with one or more of the first through seventh aspects, the function of time is measured in increments of frequency hopping cycles.

In a ninth aspect, alone or in combination with one or more of the first through eighth aspects, process 1000 includes determining (e.g., using communication manager 140 and/or determination component 1608, depicted in FIG. 16) the first cyclic shift for a first port using a first output from the function of time, and determining (e.g., using communication manager 140 and/or determination component 1608) a second cyclic shift for a second port using a second output from the function of time, where the second cyclic shift is re-determined using an offset from the first cyclic shift when the first output and the second output are the same.

In a tenth aspect, alone or in combination with one or more of the first through ninth aspects, process 1000 includes determining (e.g., using communication manager 140 and/or determination component 1608) the first cyclic shift for a first port using output from the function of time, and determining (e.g., using communication manager 140 and/or determination component 1608) a second cyclic shift for a second port using an offset from the first cyclic shift.

In an eleventh aspect, alone or in combination with one or more of the first through tenth aspects, process 1000 includes determining (e.g., using communication manager 140 and/or determination component 1608) an assignment index using output from the function of time, and determining (e.g., using communication manager 140 and/or determination component 1608) the first cyclic shift and one or more additional cyclic shifts using an assignment set corresponding to the assignment index.

In a twelfth aspect, alone or in combination with one or more of the first through eleventh aspects, the assignment index hops within a subset of a set of possible assignment indices.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network node 110 and/or apparatus 1700 of FIG. 17) performs operations associated with cyclic shift hopping.

As shown in FIG. 11, in some aspects, process 1100 may include transmitting a configuration indicating at least one uplink reference signal resource (block 1110). For example, the network entity (e.g., using communication manager 150 and/or transmission component 1704, depicted in FIG. 17) may transmit a configuration indicating at least one uplink reference signal resource, as described herein.

As further shown in FIG. 11, in some aspects, process 1100 may include receiving a plurality of uplink reference signals, using the at least one uplink reference signal resource, where a first cyclic shift for the plurality of uplink reference signals is based at least in part on a function of time measured in increments longer than one symbol (block 1120). For example, the network entity (e.g., using communication manager 150 and/or reception component 1702, depicted in FIG. 17) may receive a plurality of uplink reference signals, using the at least one uplink reference signal resource, where a first cyclic shift for the plurality of uplink reference signals is based at least in part on a function of time measured in increments longer than one symbol, as described herein.

Process 1100 may include additional aspects, such as any single aspect or any combination of aspects described below and/or in connection with one or more other processes described elsewhere herein.

In a first aspect, the plurality of uplink reference signals comprise SRSs.

In a second aspect, alone or in combination with the first aspect, the function of time comprises a pseudo-random sequence initialized by a measurement of time.

In a third aspect, alone or in combination with one or more of the first and second aspects, the first cyclic shift is associated with a first port, and one or more additional cyclic shifts are associated with one or more additional ports and are based on the first cyclic shift.

In a fourth aspect, alone or in combination with one or more of the first through third aspects, the first cyclic shift is associated with a first port and hops within a subset of a set of possible cyclic shifts.

In a fifth aspect, alone or in combination with one or more of the first through fourth aspects, the function of time is measured in increments of frequency hops.

In a sixth aspect, alone or in combination with one or more of the first through fifth aspects, the function of time is measured in increments of slots.

In a seventh aspect, alone or in combination with one or more of the first through sixth aspects, the function of time is measured in periods for the at least one uplink reference signal resource.

In an eighth aspect, alone or in combination with one or more of the first through seventh aspects, the function of time is measured in increments of frequency hopping cycles.

In a ninth aspect, alone or in combination with one or more of the first through eighth aspects, process 1100 includes determining (e.g., using communication manager 150 and/or determination component 1708, depicted in FIG. 17) the first cyclic shift associated with a first port using a first output from the function of time, and determining (e.g., using communication manager 150 and/or determination component 1708) a second cyclic shift associated with a second port using a second output from the function of time, where the second cyclic shift is re-determined using an offset from the first cyclic shift when the first output and the second output are the same.

In a tenth aspect, alone or in combination with one or more of the first through ninth aspects, process 1100 includes determining (e.g., using communication manager 150 and/or determination component 1708) the first cyclic shift associated with a first port using output from the function of time, and determining (e.g., using communication manager 150 and/or determination component 1708) a second cyclic shift associated with a second port using an offset from the first cyclic shift.

In an eleventh aspect, alone or in combination with one or more of the first through tenth aspects, process 1100 includes determining (e.g., using communication manager 150 and/or determination component 1708) an assignment index using output from the function of time, and determining (e.g., using communication manager 150 and/or determination component 1708) the first cyclic shift and one or more additional cyclic shifts using an assignment set corresponding to the assignment index.

In a twelfth aspect, alone or in combination with one or more of the first through eleventh aspects, the assignment index hops within a subset of a set of possible assignment indices.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120 and/or apparatus 1600 of FIG. 16) performs operations associated with cyclic shift hopping.

As shown in FIG. 12, in some aspects, process 1200 may include receiving a configuration indicating at least one uplink reference signal resource (block 1210). For example, the UE (e.g., using communication manager 140 and/or reception component 1602, depicted in FIG. 16) may receive a configuration indicating at least one uplink reference signal resource, as described herein.

As further shown in FIG. 12, in some aspects, process 1200 may include transmitting on a first port, using the at least one uplink reference signal resource, with a first cyclic shift (block 1220). For example, the UE (e.g., using communication manager 140 and/or transmission component 1604, depicted in FIG. 16) may transmit on a first port, using the at least one uplink reference signal resource, with a first cyclic shift, as described herein.

As further shown in FIG. 12, in some aspects, process 1200 may include transmitting on a second port, using the at least one uplink reference signal resource, with a second cyclic shift that is selected based at least in part on the first cyclic shift (block 1230). For example, the UE (e.g., using communication manager 140 and/or transmission component 1604) may transmit on a second port, using the at least one uplink reference signal resource, with a second cyclic shift that is selected based at least in part on the first cyclic shift, as described herein.

Process 1200 may include additional aspects, such as any single aspect or any combination of aspects described below and/or in connection with one or more other processes described elsewhere herein.

In a first aspect, the at least one uplink reference signal resource comprises a sounding reference signal resource.

In a second aspect, alone or in combination with the first aspect, process 1200 includes determining (e.g., using communication manager 140 and/or determination component 1608, depicted in FIG. 16) the first cyclic shift using a first output from a hopping formula, and determining (e.g., using communication manager 140 and/or determination component 1608) the second cyclic shift using a second output from the hopping formula, where the second cyclic shift is re-determined using an offset from the first cyclic shift when the first output and the second output are the same.

In a third aspect, alone or in combination with one or more of the first and second aspects, process 1200 includes receiving (e.g., using communication manager 140 and/or reception component 1602) an indication of the offset.

In a fourth aspect, alone or in combination with one or more of the first through third aspects, process 1200 includes determining (e.g., using communication manager 140 and/or determination component 1608) the first cyclic shift using output from a hopping formula, and determining (e.g., using communication manager 140 and/or determination component 1608) the second cyclic shift using an offset from the first cyclic shift.

In a fifth aspect, alone or in combination with one or more of the first through fourth aspects, the first port is associated with a first group of ports, and one or more additional cyclic shifts are assigned to one or more additional ports in the first group of ports based on the first cyclic shift.

In a sixth aspect, alone or in combination with one or more of the first through fifth aspects, the second port is associated with a second group of ports, and one or more additional cyclic shifts are assigned to one or more additional ports in the second group of ports based on the second cyclic shift.

In a seventh aspect, alone or in combination with one or more of the first through sixth aspects, process 1200 includes determining (e.g., using communication manager 140 and/or determination component 1608) an assignment index using output from a hopping formula, and determining (e.g., using communication manager 140 and/or determination component 1608) the first cyclic shift and the second cyclic shift using an assignment set corresponding to the assignment index.

In an eighth aspect, alone or in combination with one or more of the first through seventh aspects, the assignment index hops within a subset of a set of possible assignment indices.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., network node 110 and/or apparatus 1700 of FIG. 17) performs operations associated with cyclic shift hopping.

As shown in FIG. 13, in some aspects, process 1300 may include transmitting a configuration indicating at least one uplink reference signal resource (block 1310). For example, the network entity (e.g., using communication manager 150 and/or transmission component 1704, depicted in FIG. 17) may transmit a configuration indicating at least one uplink reference signal resource, as described herein.

As further shown in FIG. 13, in some aspects, process 1300 may include receiving a first uplink reference signal associated with a first port, using the at least one uplink reference signal resource, having a first cyclic shift (block 1320). For example, the network entity (e.g., using communication manager 150 and/or reception component 1702, depicted in FIG. 17) may receive a first uplink reference signal associated with a first port, using the at least one uplink reference signal resource, having a first cyclic shift, as described herein.

As further shown in FIG. 13, in some aspects, process 1300 may include receiving a second uplink reference signal associated with a second port, using the at least one uplink reference signal resource, having a second cyclic shift that is selected based at least in part on the first cyclic shift (block 1330). For example, the network entity (e.g., using communication manager 150 and/or reception component 1702) may receive a second uplink reference signal associated with a second port, using the at least one uplink reference signal resource, having a second cyclic shift that is selected based at least in part on the first cyclic shift, as described herein.

Process 1300 may include additional aspects, such as any single aspect or any combination of aspects described below and/or in connection with one or more other processes described elsewhere herein.

In a first aspect, the first and second uplink reference signals comprise SRSs.

In a second aspect, alone or in combination with the first aspect, process 1300 includes determining (e.g., using communication manager 150 and/or determination component 1708, depicted in FIG. 17) the first cyclic shift using a first output from a hopping formula, and determining (e.g., using communication manager 150 and/or determination component 1708) the second cyclic shift using a second output from the hopping formula, where the second cyclic shift is re-determined using an offset from the first cyclic shift when the first output and the second output are the same.

In a third aspect, alone or in combination with one or more of the first and second aspects, process 1300 includes transmitting (e.g., using communication manager 150 and/or transmission component 1704) an indication of the offset.

In a fourth aspect, alone or in combination with one or more of the first through third aspects, process 1300 includes determining (e.g., using communication manager 150 and/or determination component 1708) the first cyclic shift using output from a hopping formula, and determining (e.g., using communication manager 150 and/or determination component 1708) the second cyclic shift using an offset from the first cyclic shift.

In a fifth aspect, alone or in combination with one or more of the first through fourth aspects, the first port is associated with a first group of ports, and one or more additional cyclic shifts are associated with one or more additional ports in the first group of ports based on the first cyclic shift.

In a sixth aspect, alone or in combination with one or more of the first through fifth aspects, the second port is associated with a second group of ports, and one or more additional cyclic shifts are associated with one or more additional ports in the second group of ports based on the second cyclic shift.

In a seventh aspect, alone or in combination with one or more of the first through sixth aspects, process 1300 includes determining (e.g., using communication manager 150 and/or determination component 1708) an assignment index using output from a hopping formula, and determining (e.g., using communication manager 150 and/or determination component 1708) the first cyclic shift and the second cyclic shift using an assignment set corresponding to the assignment index.

In an eighth aspect, alone or in combination with one or more of the first through seventh aspects, the assignment index hops within a subset of a set of possible assignment indices.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120 and/or apparatus 1600 of FIG. 16) performs operations associated with cyclic shift hopping.

As shown in FIG. 14, in some aspects, process 1400 may include receiving a configuration indicating at least one uplink reference signal resource (block 1410). For example, the UE (e.g., using communication manager 140 and/or reception component 1602, depicted in FIG. 16) may receive a configuration indicating at least one uplink reference signal resource, as described herein.

As further shown in FIG. 14, in some aspects, process 1400 may include transmitting a plurality of uplink reference signals, using the at least one uplink reference signal resource, where a cyclic shift for a first port associated with the plurality of uplink reference signals hops within a subset of a set of possible cyclic shifts (block 1420). For example, the UE (e.g., using communication manager 140 and/or transmission component 1604, depicted in FIG. 16) may transmit a plurality of uplink reference signals, using the at least one uplink reference signal resource, where a cyclic shift for a first port associated with the plurality of uplink reference signals hops within a subset of a set of possible cyclic shifts, as described herein.

Process 1400 may include additional aspects, such as any single aspect or any combination of aspects described below and/or in connection with one or more other processes described elsewhere herein.

In a first aspect, the plurality of uplink reference signals comprise SRSs.

In a second aspect, alone or in combination with the first aspect, process 1400 includes receiving (e.g., using communication manager 140 and/or reception component 1602) an indication of the subset.

In a third aspect, alone or in combination with one or more of the first and second aspects, one or more additional cyclic shifts are assigned to one or more additional ports based on the cyclic shift for the first port.

In a fourth aspect, alone or in combination with one or more of the first through third aspects, the first port is associated with a first group of ports, and one or more additional cyclic shifts are assigned to one or more additional ports, in the first group of ports, based on the cyclic shift for the first port.

In a fifth aspect, alone or in combination with one or more of the first through fourth aspects, the cyclic shift for the first port is based at least in part on a function of time.

In a sixth aspect, alone or in combination with one or more of the first through fifth aspects, the function of time comprises a pseudo-random sequence initialized by a measurement of time.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network entity, in accordance with the present disclosure. Example process 1500 is an example where the network entity (e.g., network node 110 and/or apparatus 1700 of FIG. 17) performs operations associated with cyclic shift hopping for uplink reference signals.

As shown in FIG. 15, in some aspects, process 1500 may include transmitting a configuration indicating at least one uplink reference signal resource (block 1510). For example, the network entity (e.g., using communication manager 150 and/or transmission component 1704, depicted in FIG. 17) may transmit a configuration indicating at least one uplink reference signal resource, as described herein.

As further shown in FIG. 15, in some aspects, process 1500 may include receiving a plurality of uplink reference signals, using the at least one uplink reference signal resource, where a cyclic shift for a first port associated with the plurality of uplink reference signals hops within a subset of a set of possible cyclic shifts (block 1520). For example, the network entity (e.g., using communication manager 150 and/or reception component 1702, depicted in FIG. 17) may receive a plurality of uplink reference signals, using the at least one uplink reference signal resource, where a cyclic shift for a first port associated with the plurality of uplink reference signals hops within a subset of a set of possible cyclic shifts, as described herein.

Process 1500 may include additional aspects, such as any single aspect or any combination of aspects described below and/or in connection with one or more other processes described elsewhere herein.

In a first aspect, the plurality of uplink reference signals comprise SRSs.

In a second aspect, alone or in combination with the first aspect, process 1500 includes transmitting (e.g., using communication manager 150 and/or transmission component 1704) an indication of the subset.

In a third aspect, alone or in combination with one or more of the first and second aspects, one or more additional cyclic shifts are associated with one or more additional ports and are based on the cyclic shift for the first port.

In a fourth aspect, alone or in combination with one or more of the first through third aspects, the first port is associated with a first group of ports, and one or more additional cyclic shifts are associated with one or more additional ports, in the first group of ports, based on the cyclic shift for the first port.

In a fifth aspect, alone or in combination with one or more of the first through fourth aspects, the cyclic shift for the first port is based at least in part on a function of time.

In a sixth aspect, alone or in combination with one or more of the first through fifth aspects, the function of time comprises a pseudo-random sequence initialized by a measurement of time.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, an RU, or another wireless communication device) using the reception component 1602 and the transmission component 1604. As further shown, the apparatus 1600 may include the communication manager 140. The communication manager 140 may include one or more of a determination component 1608 and/or a sequencing component 1610, among other examples.

In some aspects, the apparatus 1600 may be configured to perform one or more operations described herein in connection with FIGS. 6-9. Additionally, or alternatively, the apparatus 1600 may be configured to perform one or more processes described herein, such as process 1000 of FIG. 10, process 1200 of FIG. 12, process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

In some aspects, the reception component 1602 may receive a configuration indicating at least one uplink reference signal resource. The transmission component 1604 may transmit a plurality of uplink reference signals, using the at least one uplink reference signal resource. For example, the sequencing component 1610 may select at least one base sequence used to generate the plurality of uplink reference signals. A first cyclic shift for the plurality of uplink reference signals may be based at least in part on a function of time measured in increments longer than one symbol.

In some aspects, the determination component 1608 may determine the first cyclic shift for a first port using a first output from the function of time. Additionally, in some aspects, the determination component 1608 may determine a second cyclic shift for a second port using a second output from the function of time. The second cyclic shift may be re-determined using an offset from the first cyclic shift when the first output and the second output are the same. Alternatively, the determination component 1608 may determine the second cyclic shift using an offset from the first cyclic shift.

Alternatively, the determination component 1608 may determine an assignment index using output from the function of time. Accordingly, the determination component 1608 may determine the first cyclic shift and one or more additional cyclic shifts using an assignment set corresponding to the assignment index.

In some aspects, the transmission component 1604 may transmit on a first port, using the at least one uplink reference signal resource, with a first cyclic shift. The transmission component 1604 may further transmit on a second port, using the at least one uplink reference signal resource, with a second cyclic shift that is selected based at least in part on the first cyclic shift.

In some aspects, the determination component 1608 may determine the first cyclic shift using a first output from a hopping formula. Additionally, in some aspects, the determination component 1608 may determine the second cyclic shift using a second output from the hopping formula. The second cyclic shift may be re-determined using an offset from the first cyclic shift when the first output and the second output are the same. Alternatively, the determination component 1608 may determine the second cyclic shift using an offset from the first cyclic shift.

In some aspects, the determination component 1608 may determine an assignment index using output from a hopping formula. Accordingly, the determination component 1608 may determine the first cyclic shift and the second cyclic shift using an assignment set corresponding to the assignment index.

In any aspects described above, a cyclic shift for a first port may hop within a subset of a set of possible cyclic shifts.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network entity, or a network entity may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, an RU, or another wireless communication device) using the reception component 1702 and the transmission component 1704. As further shown, the apparatus 1700 may include the communication manager 150. The communication manager 150 may include one or more of a determination component 1708 and/or a cyclic shift component 1710, among other examples.

In some aspects, the apparatus 1700 may be configured to perform one or more operations described herein in connection with FIGS. 6-9. Additionally, or alternatively, the apparatus 1700 may be configured to perform one or more processes described herein, such as process 1100 of FIG. 11, process 1300 of FIG. 13, process 1500 of FIG. 15, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver.

In some aspects, the transmission component 1704 may transmit a configuration indicating at least one uplink reference signal resource. Accordingly, the reception component 1702 may receive a plurality of uplink reference signals, using the at least one uplink reference signal resource. For example, the cyclic shift component 1710 may apply a first cyclic shift for the plurality of uplink reference signals based at least in part on a function of time measured in increments longer than one symbol.

In some aspects, the determination component 1708 may determine the first cyclic shift associated with a first port using a first output from the function of time. Additionally, in some aspects, the determination component 1708 may determine a second cyclic shift associated with a second port using a second output from the function of time. The second cyclic shift may be re-determined using an offset from the first cyclic shift when the first output and the second output are the same. Alternatively, the determination component 1708 may determine a second cyclic shift associated with a second port using an offset from the first cyclic shift.

Alternatively, the determination component 1708 may determine an assignment index using output from the function of time. Accordingly, the determination component 1708 may determine the first cyclic shift and one or more additional cyclic shifts using an assignment set corresponding to the assignment index.

In some aspects, the reception component 1702 may receive a first uplink reference signal associated with a first port, using the at least one uplink reference signal resource, having a first cyclic shift. The reception component 1702 may further receive a second uplink reference signal associated with a second port, using the at least one uplink reference signal resource, having a second cyclic shift that is selected based at least in part on the first cyclic shift.

In some aspects, the determination component 1708 may determine the first cyclic shift using a first output from a hopping formula. Additionally, in some aspects, the determination component 1708 may determine the second cyclic shift using a second output from the hopping formula. The second cyclic shift may be re-determined using an offset from the first cyclic shift when the first output and the second output are the same. Alternatively, the determination component 1708 may determine the second cyclic shift using an offset from the first cyclic shift.

In some aspects, the determination component 1708 may determine an assignment index using output from a hopping formula. Accordingly, the determination component 1708 may determine the first cyclic shift and the second cyclic shift using an assignment set corresponding to the assignment index.

In any aspects described above, a cyclic shift for a first port associated with the plurality of uplink reference signals hops within a subset of a set of possible cyclic shifts.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:
Aspect 1: A method of wireless communication performed by a user equipment (UE), comprising: receiving a configuration indicating at least one uplink reference signal resource; and transmitting a plurality of uplink reference signals, using the at least one uplink reference signal resource, wherein a first cyclic shift for the plurality of uplink reference signals is based at least in part on a function of time measured in increments longer than one symbol.
Aspect 2: The method of Aspect 1, wherein the plurality of uplink reference signals comprise sounding reference signals.
Aspect 3: The method of any of Aspects 1 through 2, wherein the function of time comprises a pseudo-random sequence initialized by a measurement of time.
Aspect 4: The method of any of Aspects 1 through 3, wherein the first cyclic shift is assigned to a first port associated with the at least one uplink reference signal resource, and one or more additional cyclic shifts are assigned to one or more additional ports based on the first cyclic shift.
Aspect 5: The method of any of Aspects 1 through 4, wherein the first cyclic shift is assigned to a first port and hops within a subset of a set of possible cyclic shifts.
Aspect 6: The method of any of Aspects 1 through 5, wherein the function of time is measured in increments of frequency hops.
Aspect 7: The method of any of Aspects 1 through 5, wherein the function of time is measured in increments of slots.
Aspect 8: The method of any of Aspects 1 through 5, wherein the function of time is measured in periods for the at least one uplink reference signal resource.
Aspect 9: The method of any of Aspects 1 through 5, wherein the function of time is measured in increments of frequency hopping cycles.
Aspect 10: The method of any of Aspects 1 through 9, further comprising: determining the first cyclic shift for a first port using a first output from the function of time; and determining a second cyclic shift for a second port using a second output from the function of time, wherein the second cyclic shift is re-determined using an offset from the first cyclic shift when the first output and the second output are the same.
Aspect 11: The method of any of Aspects 1 through 9, further comprising: determining the first cyclic shift for a first port using output from the function of time; and determining a second cyclic shift for a second port using an offset from the first cyclic shift.
Aspect 12: The method of any of Aspects 1 through 9, further comprising: determining an assignment index using output from the function of time; and determining the first cyclic shift and one or more additional cyclic shifts using an assignment set corresponding to the assignment index.
Aspect 13: The method of Aspect 12, wherein the assignment index hops within a subset of a set of possible assignment indices.
Aspect 14: A method of wireless communication performed by a network entity, comprising: transmitting a configuration indicating at least one uplink reference signal resource; and receiving a plurality of uplink reference signals, using the at least one uplink reference signal resource, wherein a first cyclic shift for the plurality of uplink reference signals is based at least in part on a function of time measured in increments longer than one symbol.
Aspect 15: The method of Aspect 14, wherein the plurality of uplink reference signals comprise sounding reference signals.
Aspect 16: The method of any of Aspects 14 through 15, wherein the function of time comprises a pseudo-random sequence initialized by a measurement of time.
Aspect 17: The method of any of Aspects 14 through 16, wherein the first cyclic shift is associated with a first port, and one or more additional cyclic shifts are associated with one or more additional ports and are based on the first cyclic shift.
Aspect 18: The method of any of Aspects 14 through 17, wherein the first cyclic shift is associated with a first port and hops within a subset of a set of possible cyclic shifts.
Aspect 19: The method of any of Aspects 14 through 18, wherein the function of time is measured in increments of frequency hops.
Aspect 20: The method of any of Aspects 14 through 18, wherein the function of time is measured in increments of slots.
Aspect 21: The method of any of Aspects 14 through 18, wherein the function of time is measured in periods for the at least one uplink reference signal resource.
Aspect 22: The method of any of Aspects 14 through 18, wherein the function of time is measured in increments of frequency hopping cycles.
Aspect 23: The method of any of Aspects 14 through 22, further comprising: determining the first cyclic shift associated with a first port using a first output from the function of time; and determining a second cyclic shift associated with a second port using a second output from the function of time, wherein the second cyclic shift is re-determined using an offset from the first cyclic shift when the first output and the second output are the same.
Aspect 24: The method of any of Aspects 14 through 22, further comprising: determining the first cyclic shift associated with a first port using output from the function of time; and determining a second cyclic shift associated with a second port using an offset from the first cyclic shift.
Aspect 25: The method of any of Aspects 14 through 22, further comprising: determining an assignment index using output from the function of time; and determining the first cyclic shift and one or more additional cyclic shifts using an assignment set corresponding to the assignment index.
Aspect 26: The method of Aspect 25, wherein the assignment index hops within a subset of a set of possible assignment indices.
Aspect 27: A method of wireless communication performed by a user equipment (UE), comprising: receiving a configuration indicating at least one uplink reference signal resource; transmitting on a first port, using the at least one uplink reference signal resource, with a first cyclic shift; and transmitting on a second port, using the at least one uplink reference signal resource, with a second cyclic shift that is selected based at least in part on the first cyclic shift.
Aspect 28: The method of Aspect 27, wherein the at least one uplink reference signal resource comprises a sounding reference signal resource.
Aspect 29: The method of any of Aspects 27 through 28, further comprising: determining the first cyclic shift using a first output from a hopping formula; and determining the second cyclic shift using a second output from the hopping formula, wherein the second cyclic shift is re-determined using an offset from the first cyclic shift when the first output and the second output are the same.
Aspect 30: The method of Aspect 29, further comprising: receiving an indication of the offset.
Aspect 31: The method of any of Aspects 27 through 28, further comprising: determining the first cyclic shift using output from a hopping formula; and determining the second cyclic shift using an offset from the first cyclic shift.
Aspect 32: The method of Aspect 31, further comprising: receiving an indication of the offset.
Aspect 33: The method of any of Aspects 27 through 32, wherein the first port is associated with a first group of ports, and one or more additional cyclic shifts are assigned to one or more additional ports in the first group of ports based on the first cyclic shift.
Aspect 34: The method of any of Aspects 27 through 33, wherein the second port is associated with a second group of ports, and one or more additional cyclic shifts are assigned to one or more additional ports in the second group of ports based on the second cyclic shift.
Aspect 35: The method of any of Aspects 27 through 28, further comprising: determining an assignment index using output from a hopping formula; and determining the first cyclic shift and the second cyclic shift using an assignment set corresponding to the assignment index.
Aspect 36: The method of Aspect 35, wherein the assignment index hops within a subset of a set of possible assignment indices.
Aspect 37: A method of wireless communication performed by a network entity, comprising: transmitting a configuration indicating at least one uplink reference signal resource; receiving a first uplink reference signal associated with a first port, using the at least one uplink reference signal resource, having a first cyclic shift; and receiving a second uplink reference signal associated with a second port, using the at least one uplink reference signal resource, having a second cyclic shift that is selected based at least in part on the first cyclic shift.
Aspect 38: The method of Aspect 37, wherein the first and second uplink reference signals comprise sounding reference signals.
Aspect 39: The method of any of Aspects 37 through 38, further comprising: determining the first cyclic shift using a first output from a hopping formula; and determining the second cyclic shift using a second output from the hopping formula, wherein the second cyclic shift is re-determined using an offset from the first cyclic shift when the first output and the second output are the same.
Aspect 40: The method of Aspect 39, further comprising: transmitting an indication of the offset.
Aspect 41: The method of any of Aspects 37 through 38, further comprising: determining the first cyclic shift using output from a hopping formula; and determining the second cyclic shift using an offset from the first cyclic shift.
Aspect 42: The method of Aspect 41, further comprising: transmitting an indication of the offset.
Aspect 43: The method of any of Aspects 37 through 42, wherein the first port is associated with a first group of ports, and one or more additional cyclic shifts are associated with one or more additional ports in the first group of ports based on the first cyclic shift.
Aspect 44: The method of any of Aspects 37 through 43, wherein the second port is associated with a second group of ports, and one or more additional cyclic shifts are associated with one or more additional ports in the second group of ports based on the second cyclic shift.
Aspect 45: The method of any of Aspects 37 through 38, further comprising: determining an assignment index using output from a hopping formula; and determining the first cyclic shift and the second cyclic shift using an assignment set corresponding to the assignment index.
Aspect 46: The method of Aspect 45, wherein the assignment index hops within a subset of a set of possible assignment indices.
Aspect 47: A method of wireless communication performed by a user equipment (UE), comprising: receiving a configuration indicating at least one uplink reference signal resource; and transmitting a plurality of uplink reference signals, using the at least one uplink reference signal resource, wherein a cyclic shift for a first port associated with the plurality of uplink reference signals hops within a subset of a set of possible cyclic shifts.
Aspect 48: The method of Aspect 47, wherein the plurality of uplink reference signals comprise sounding reference signals.
Aspect 49: The method of any of Aspects 47 through 48, further comprising: receiving an indication of the subset.
Aspect 50: The method of any of Aspects 47 through 48, wherein one or more additional cyclic shifts are assigned to one or more additional ports based on the cyclic shift for the first port.
Aspect 51: The method of any of Aspects 47 through 48, wherein the first port is associated with a first group of ports, and one or more additional cyclic shifts are assigned to one or more additional ports, in the first group of ports, based on the cyclic shift for the first port.
Aspect 52: The method of any of Aspects 47 through 51, wherein the cyclic shift for the first port is based at least in part on a function of time.
Aspect 53: The method of Aspect 52, wherein the function of time comprises a pseudo-random sequence initialized by a measurement of time.
Aspect 54: A method of wireless communication performed by a network entity, comprising: transmitting a configuration indicating at least one uplink reference signal resource; and receiving a plurality of uplink reference signals, using the at least one uplink reference signal resource, wherein a cyclic shift for a first port associated with the plurality of uplink reference signals hops within a subset of a set of possible cyclic shifts.
Aspect 55: The method of Aspect 54, wherein the plurality of uplink reference signals comprise sounding reference signals.
Aspect 56: The method of any of Aspects 54 through 55, further comprising: transmitting an indication of the subset.
Aspect 57: The method of any of Aspects 54 through 56, wherein one or more additional cyclic shifts are associated with one or more additional ports and are based on the cyclic shift for the first port.
Aspect 58: The method of any of Aspects 54 through 56, wherein the first port is associated with a first group of ports, and one or more additional cyclic shifts are associated with one or more additional ports, in the first group of ports, based on the cyclic shift for the first port.
Aspect 59: The method of any of Aspects 54 through 58, wherein the cyclic shift for the first port is based at least in part on a function of time.
Aspect 60: The method of Aspect 59, wherein the function of time comprises a pseudo-random sequence initialized by a measurement of time.
Aspect 61: An apparatus for wireless communication at a device, comprising a processor; memory coupled with the processor; and instructions stored in the memory and executable by the processor to cause the apparatus to perform the method of one or more of Aspects 1-60.
Aspect 62: A device for wireless communication, comprising a memory and one or more processors coupled to the memory, the one or more processors configured to perform the method of one or more of Aspects 1-60.
Aspect 63: An apparatus for wireless communication, comprising at least one means for performing the method of one or more of Aspects 1-60.
Aspect 64: A non-transitory computer-readable medium storing code for wireless communication, the code comprising instructions executable by a processor to perform the method of one or more of Aspects 1-60.
Aspect 65: A non-transitory computer-readable medium storing a set of instructions for wireless communication, the set of instructions comprising one or more instructions that, when executed by one or more processors of a device, cause the device to perform the method of one or more of Aspects 1-60.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a configuration indicating at least one uplink reference signal resource; and
transmit a plurality of uplink reference signals, using the at least one uplink reference signal resource, wherein a cyclic shift for a first port associated with the plurality of uplink reference signals hops within a subset of a set of possible cyclic shifts.

2. The apparatus of claim 1, wherein the plurality of uplink reference signals comprise sounding reference signals.

3. The apparatus of claim 1, wherein the one or more processors are further configured to:
receive an indication of the subset.

4. The apparatus of claim 1, wherein one or more additional cyclic shifts are assigned to one or more additional ports based on the cyclic shift for the first port.

5. The apparatus of claim 1, wherein the first port is associated with a first group of ports, and one or more additional cyclic shifts are assigned to one or more additional ports, in the first group of ports, based on the cyclic shift for the first port.

6. The apparatus of claim 1, wherein the cyclic shift for the first port is based at least in part on a function of time.

7. The apparatus of claim 6, wherein the function of time comprises a pseudo-random sequence initialized by a measurement of time.

8. An apparatus for wireless communication at a network entity, comprising:
a memory; and
one or more processors, coupled to the memory, configured to:
transmit a configuration indicating at least one uplink reference signal resource; and
receive a plurality of uplink reference signals, using the at least one uplink reference signal resource, wherein a cyclic shift for a first port associated with the plurality of uplink reference signals hops within a subset of a set of possible cyclic shifts.

9. The apparatus of claim 8, wherein the plurality of uplink reference signals comprise sounding reference signals.

10. The apparatus of claim 8, wherein the one or more processors are further configured to:
transmit an indication of the subset.

11. The apparatus of claim 8, wherein one or more additional cyclic shifts are associated with one or more additional ports and are based on the cyclic shift for the first port.

12. The apparatus of claim 8, wherein the first port is associated with a first group of ports, and one or more additional cyclic shifts are associated with one or more additional ports, in the first group of ports, based on the cyclic shift for the first port.

13. The apparatus of claim 8, wherein the cyclic shift for the first port is based at least in part on a function of time.

14. The apparatus of claim 13, wherein the function of time comprises a pseudo-random sequence initialized by a measurement of time.

15. A method of wireless communication performed by a user equipment (UE), comprising:
receiving a configuration indicating at least one uplink reference signal resource; and
transmitting a plurality of uplink reference signals, using the at least one uplink reference signal resource, wherein a cyclic shift for a first port associated with the plurality of uplink reference signals hops within a subset of a set of possible cyclic shifts.

16. The method of claim 15, wherein the plurality of uplink reference signals comprise sounding reference signals.

17. The method of claim 15, further comprising:
receiving an indication of the subset.

18. The method of claim 15, wherein one or more additional cyclic shifts are assigned to one or more additional ports based on the cyclic shift for the first port.

19. The method of claim 15, wherein the first port is associated with a first group of ports, and one or more additional cyclic shifts are assigned to one or more additional ports, in the first group of ports, based on the cyclic shift for the first port.

20. The method of claim 15, wherein the cyclic shift for the first port is based at least in part on a function of time.

21. The method of claim 20, wherein the function of time comprises a pseudo-random sequence initialized by a measurement of time.

22. A method of wireless communication performed by a network entity, comprising:
transmitting a configuration indicating at least one uplink reference signal resource; and
receiving a plurality of uplink reference signals, using the at least one uplink reference signal resource, wherein a cyclic shift for a first port associated with the plurality of uplink reference signals hops within a subset of a set of possible cyclic shifts.

23. The method of claim 22, wherein the plurality of uplink reference signals comprise sounding reference signals.

24. The method of claim 22, further comprising:
transmitting an indication of the subset.

25. The method of claim 22, wherein one or more additional cyclic shifts are associated with one or more additional ports and are based on the cyclic shift for the first port.

26. The method of claim 22, wherein the first port is associated with a first group of ports, and one or more additional cyclic shifts are associated with one or more additional ports, in the first group of ports, based on the cyclic shift for the first port.

27. The method of claim 22, wherein the cyclic shift for the first port is based at least in part on a function of time.

28. The method of claim 27, wherein the function of time comprises a pseudo-random sequence initialized by a measurement of time.
